(19) United States
(12) Patent Application Publication
(10) Pub. No.: US 2026/0203662 A1
(43) Pub. Date: Jul. 16, 2026

(54) SYSTEM AND METHOD FOR DATA ANALYSIS AND PREDICTION

(71) Applicant: University of Rochester, Rochester, NY (US)

(72) Inventor: Tong Geng, Rochester, NY (US)

(21) Appl. No.: 19/451,524

(22) Filed: Jan. 16, 2026

Related U.S. Application Data
(60) Provisional application No. 63/745,853, filed on Jan. 16, 2025.

(51) Int. Cl. G06N 20/00; G06N 5/022

(52) U.S. Cl. CPC G06N 20/00; G06N 5/022

(57) ABSTRACT

A system for data analysis and prediction includes at least one processing unit configured to divide input data into multiple partitions, wherein each partition comprises nodes corresponding to previous, current, and future time states represented as spins, and wherein the processing unit is configured to fix the spins of the nodes of the previous and current time steps to historical data; and one or more Ising machines coupled to the at least one processing unit configured to predict spins of nodes for future time states by evolving the system toward a spin configuration with the lowest energy state. A method for data analysis and prediction is also disclosed.

### CROSS-REFERENCE TO RELATED APPLICATIONS

This application claims priority to U.S. Provisional Application No. 63/745,853 filed on Jan. 16, 2025, incorporated herein by reference in its entirety.

### STATEMENT REGARDING FEDERALLY SPONSORED RESEARCH OR DEVELOPMENT

This invention was made with government support under 2326494 awarded by the National Science Foundation. The government has certain rights in the invention.

### BACKGROUND OF THE INVENTION

Nature performs complex computations constantly at clearly lower cost and higher performance than digital computers. It is crucial to understand how to harness the unique computational power of nature in Machine Learning (ML). In the past decade, besides the development of Neural Networks (NNs), the community has also relentlessly explored nature-powered ML paradigms. Although most of them are still predominantly theoretical, a new practical paradigm enabled by the recent advent of CMOS-compatible room-temperature nature-based computers has emerged. By harnessing a dynamical system's intrinsic behavior of chasing the lowest energy state, this paradigm can solve some simple binary problems delivering considerable speedup and energy savings compared with NNs, while maintaining comparable accuracy. Regrettably, its values to the real world are highly constrained by its binary nature. A clear pathway to its extension to real-valued problems remains elusive.

With the rapid digitization of the world, an increasing number of real-world applications are turning to non-Euclidean data, modeled as graphs. Due to their intrinsic high complexity and irregularity, learning from graph data demands tremendous computational power. Recently, CMOS-compatible Ising machines, i.e., dynamical systems fabricated with CMOS technologies, have emerged as a new approach that harnesses the inherent power of nature within dynamical systems to efficiently resolve binary optimization problems and have been adopted for traditional graph computation, such as max-cut. However, when performing complex Graph Learning (GL) tasks, Ising machines face significant hurdles: i) they are binary and thus ill-suited for real-valued problems; ii) their expensive all-to-all coupling network that guarantees generality for optimization problems poses daunting scalability concerns.

Thus, there is a need in the art for Ising machines for real-valued problems, in order to address dynamical systems and non-binary applications. The present invention satisfies that need.

### SUMMARY OF THE INVENTION

A system for data analysis and prediction includes at least one processing unit configured to divide input data into multiple partitions, wherein each partition comprises nodes corresponding to previous, current, and future time states represented as spins, and wherein the processing unit is configured to fix the spins of the nodes of the previous and current time steps to historical data; and one or more Ising machines coupled to the at least one processing unit configured to predict spins of nodes for future time states by evolving the system toward a spin configuration with the lowest energy state.

In some embodiments, the one or more Ising machines implement a Hamiltonian function modified to support any of real-valued state data, dynamical machines, machine learning (ML), graph learning, and any combinations thereof. In some embodiments, the at least one processing unit comprises a mesh-based network of a plurality of processing elements (PEs) connected to a plurality of coupling units (CUs). In some embodiments, each PE comprises one or more buffers, routers, and digital controllers for support of co-annealing in the processing unit. In some embodiments, each CU comprises a mini coupling crossbar configurable for one or more types of connections to bridge neighboring PEs.

In some embodiments, the evolution toward the spin configuration with the lowest energy state is achieved using a co-annealing process that integrates spatial and temporal relationships. In some embodiments, the one or more Ising machine are configured for electron-speed annealing with asynchronous spin flipping. In some embodiments, one or more of the spins are allowed to stabilize at intermediate states. In some embodiments, the processing unit and one or more Ising machines are coupled using a mesh-based architecture with a plurality of interconnected processing elements.

In some embodiments, the mesh-based network comprises direct interconnections between non-neighboring PEs to reduce communication latency. In some embodiments, coupling strengths between spins are learned during a training phase such that historical data corresponds to a lower-energy configuration than alternative configurations. In some embodiments, the processing unit is configured to selectively establish direct coupling paths between non-adjacent processing elements of the processing unit to exchange spin information. In some embodiments, each node comprises a resistive feedback loop configured to regulate current flow and stabilize a node state at a non-binary value.

In some embodiments, the predictions for future nodes are used in real-time applications, including live data, graph data, live graph data, traffic forecasting, air quality monitoring, disease or pandemic progression modeling. In some embodiments, the system includes a visualization module to display predicted future data alongside historical data for analysis. In some embodiments, the system is CMOS-based. In some embodiments, the one or more Ising machines comprise modified Ising machines configured to represent or embody one or more dynamical systems.

A method for data analysis and prediction includes providing a disclosed system for data analysis and prediction, dividing input data into multiple partitions, wherein each partition comprises nodes corresponding to previous, current, and future time states represented by spins, fixing the spins of the nodes in the partitions corresponding to the previous and current time states based on historical data, representing the data as an energy-based model with parameters that define relationships between nodes, evolving the model toward a configuration with the lowest energy state using one or more Ising machines, and predicting the spins of nodes in the partition corresponding to the future time states based on the evolved configuration, and inferring data based on the prediction.

In some embodiments, the data analysis and prediction is used for any of dynamical machines, graph-based predictions, traffic flow predictions, pandemic progression modelling, air quality monitoring, optimization problems, supply chain optimization, network optimization, machine learning, real-time dynamic systems, disaster response, molecular simulations, energy optimization, real-valued data prediction. In some embodiments, the one or more Ising machines comprise modified Ising machines configured to represent or embody one or more dynamical systems.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a diagram showing an overview of the end-to-end Nature-Powered Graph Learning (NP-GL) framework.

FIG. 1B is a series of diagrams showing an exemplary workflow of NP-GL, involving Hamiltonian mapping, training, and interference steps.

FIG. 1C is a diagram showing the fine-tuning of a pre-trained spatial model. J_{AB}: the coupling between Spin A and B.

FIG. 1D is a diagram showing the nature-based computer upgraded from its binary predecessor to support real values.

FIG. 2A is a diagram showing the overview of an exemplary Dynamical System Graph Learning (DS-GL) framework and its performance over Graph Neural Networks (GNNs).

FIG. 2B is a diagram showing the overview of an exemplary Bistable resistively-coupled Ising machine (BRIM) hardware architecture.

FIG. 2C is a diagram showing the real-Valued Dynamical System Processing unit (DSPU) architecture.

FIG. 2D is a diagram showing the workflow of Scalable DS-GL.

FIG. 2E is a diagram showing the four types of communication patterns.

FIG. 2F is a diagram showing the hardware architecture of Scalable DSPU.

FIG. 2G is a diagram showing the detailed PE-to-CU connections via Analog I/O.

FIG. 2H is a diagram showing the hardware architecture for Spatial co-annealing and Spatial & Temporal co-annealing methods.

FIG. 3 is a diagram of a computing environment.

FIG. 4 is a diagram depicting an exemplary method for data analysis and prediction.

FIG. 5 is a diagram showing the latency comparison of CPU, GPU, and NP-GL nature-based computer.

FIG. 6 is a diagram showing the natural process of energy decrease in NP-GL computer to find desired inference results.

FIG. 7 is a diagram showing the data distribution comparison of the predicted data and ground truth data.

FIG. 8 is a set of plots showing the circuit-level validation.

FIG. 9 is a series of plots showing the DS-GL accuracy (Root mean square deviation (RMSE)) vs the density of coupling matrix (proportion of nonzero elements; sparsity=1−density) with different communication patterns.

FIG. 10 is a series of plots showing the DS-GL Accuracy vs inference latency (annealing time).

FIG. 11 is a series of plots showing the RMSE vs Synchronization Interval, with 200 ns used in DS-GL.

FIG. 12 is a series of plots showing the RMSE vs matrix density under noise percentage n.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, and +0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The present disclosure relates to various systems and methods comprising or utilizing machine learning (ML) algorithms and models, neural networks (NN), graph neural networks (GNNs), graph learning frameworks, and/or Ising machines and models. In some embodiments, the systems and methods are configured for Ising Graph Learning (IGL). In some embodiments, the systems and methods are configured for IGL, Dynamical System Graph Learning (DS-GL), and/or Nature-Powered Graph Learning (NP-GL), and utilizes various frameworks thereof. In some embodiments, the disclosed systems and methods leverage nature-inspired computing to advance graph learning by utilizing and extending the principles of Ising machines. In some embodiments, the disclosed systems include hardware implementations of modified Ising models, such as Hamiltonian functions adapted to handle real-valued data, enabling applications beyond traditional binary optimization. The disclosed methods comprise training algorithms, including conditional likelihood optimization and techniques like spatial pre-training and temporal fine-tuning, to optimize energy landscapes for graph-based data. Additionally, scalable architectures with mesh-based processing elements and co-annealing techniques are introduced to handle large-scale, dynamic graphs and enable real-time inference with high computational efficiency and reduced energy consumption. The disclosed systems and methods may be configured to address challenges in real-time prediction, large-scale graph processing, and energy efficiency, with applications in traffic prediction, air quality monitoring, and pandemic progression modeling.

Specifically, Ising machines as a physical embodiment of the Ising model can be thought of as a dynamical system governed by the Hamiltonian (energy function of a dynamical system) of the Ising model. Driven by the spontaneous energy decrease in nature, a CMOS-based Ising machine can swiftly and automatically chase and find its lowest-energy states at the “speed of electrons” with negligible costs-mW power & ns latency. Unsurprisingly, the unique computational power of Ising machines has enabled a new nature-powered ML paradigm-termed “Ising Graph Learning (IGL)” in this disclosure. In IGL, a graph problem (e.g., time series forecasting) is formulated as an Ising model whose parameters are trained to map the problem's desired (e.g., prediction) results with higher probabilities to the lower energy states of the Ising machine, enabling the Ising machine to automatically find the desired solution at extreme speed. It has been demonstrated herein that the disclosed IGL outperforms graph neural networks (GNNs) with orders of magnitude speedups maintaining competitive accuracy in simple real-world graph learning applications with binary data, e.g., traffic congestion prediction and collaborative filtering.

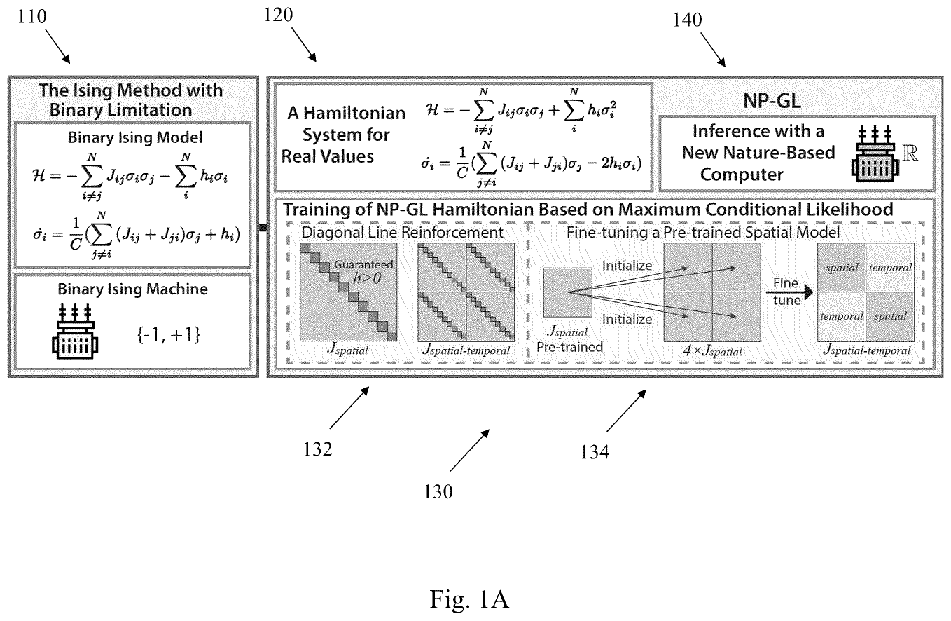

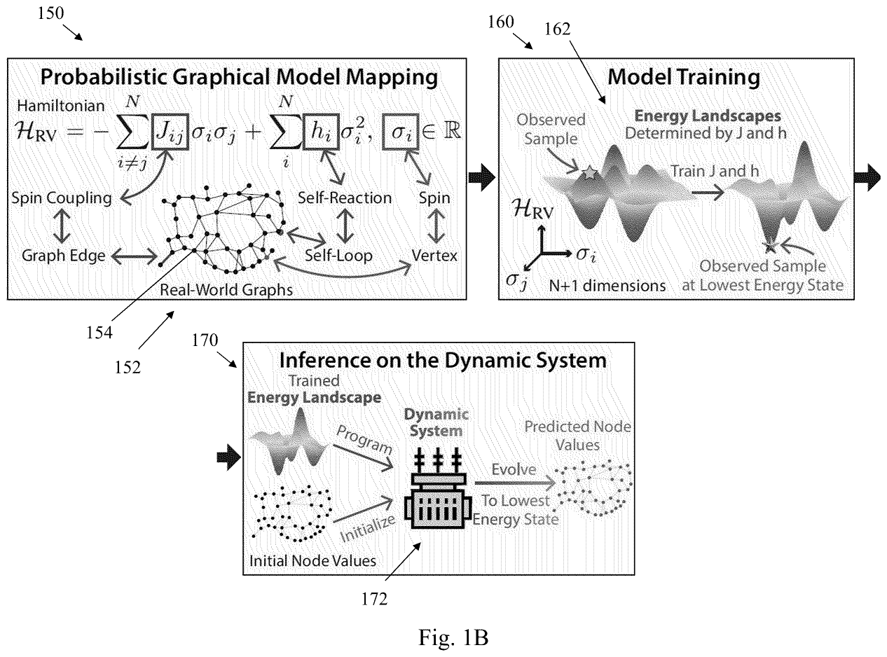

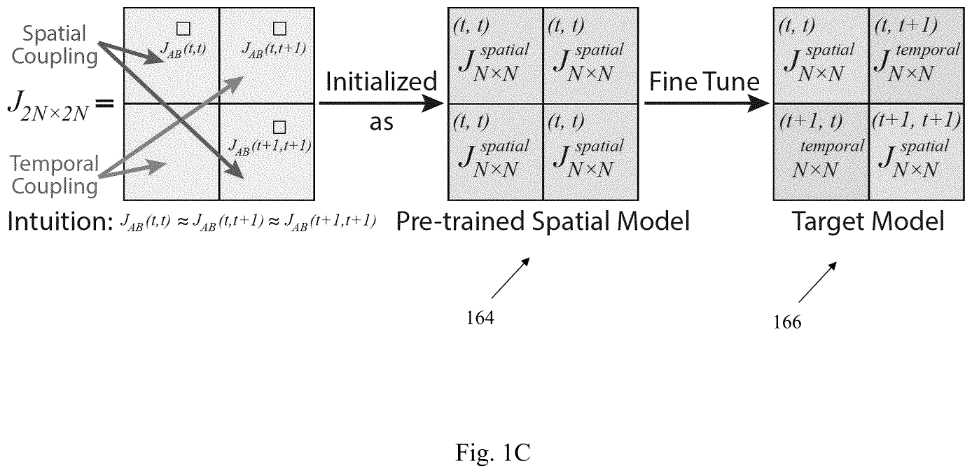

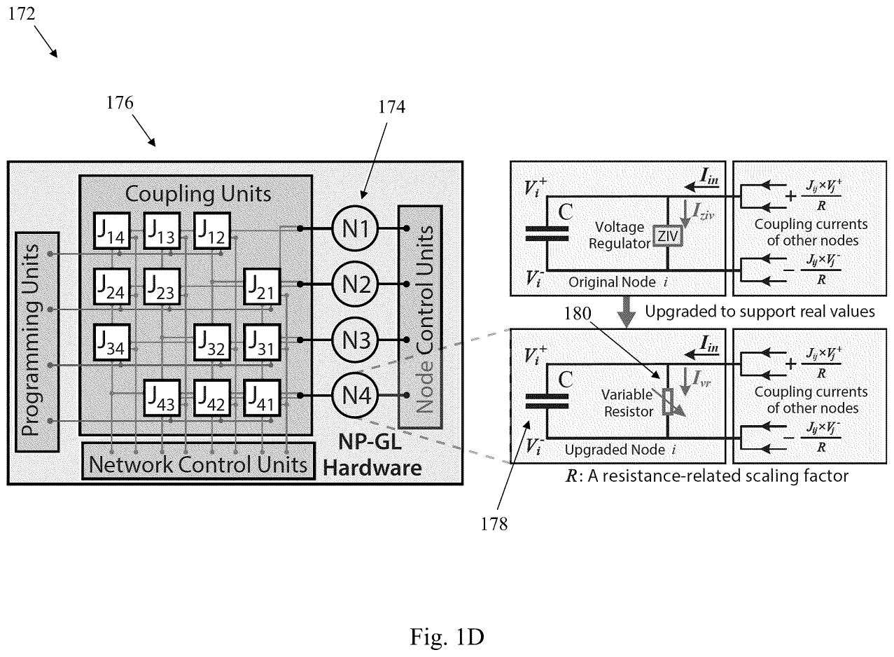

In some embodiments, the disclosed system comprises an end-to-end Nature-Powered Graph Learning (NP-GL) framework, extending nature's computing power inherent in dynamical systems to tackle real-valued and real-world graph learning problems. FIG. 1A is a diagram showing an overview of the end-to-end Nature-Powered Graph Learning (NP-GL) framework. The framework's overview, encompassing four components, is depicted in FIG. 1A: Limitation analysis of Ising Graph Learning 110: Why the vanilla Ising Graph Learning (including both the Ising model and Ising machine) cannot be straightforwardly extended to support real values without upgrading the Ising Hamiltonian is analyzed. Exploration of NP-GL Hamiltonian 120: Based on the analysis, NP-GL incorporates a newly designed Hamiltonian that is highly hardware-friendly. It inherits the strengths of the Ising model, ensuring high expressivity, and maintains distinct stable states with real values. Design of NP-GL training algorithms 130: Similarly to Ising Graph Learning, the parameters of the new Hamiltonian are trained to construct an energy landscape, in which the lowest-energy states correspond to the ground truth derived from historical data. In pursuit of high accuracy, NP-GL training adopts an improved conditional likelihood method with two optimizations: 1) Diagonal Line

Reinforcement 132, which reinforces the self-reaction parameters for better temporal continuity and differentiates the training of self-reaction (diagonal) and coupling parameters that convey distinct physical information. 2) Spatial Pre-training coupled with Temporal Fine-tuning 134, which leverages the similarity between spatial and temporal correlations to better learn from the temporal information. Design of NP-GL nature-based computer 140: Due to the similarity between NP-GL and Ising Hamiltonians, the new nature-based computer governed by the NP-GL Hamiltonian is built by slightly augmenting the circuitry of the Ising machine. The new nature-based computer, like Ising machines, leverages nature's power to swiftly find the lowest-energy states, but, unlike them, it does so with real values.

NP-GL is the first end-to-end real-valued nature-powered ML solution that outperforms NNs in the real world. In some embodiments NP-GL is an end-to-end nature-powered graph learning method, through codesign of Hamiltonian, training algorithms, and nature-based hardware. In some embodiments, NP-GL lifts the binary limitation of existing nature-powered ML methods and extends their applicability to real-valued problems. Disclosed is a new hardware-friendly Hamiltonian for real-valued support, coupled with an efficient training method with two optimizations that ensure high training speed and quality; and further disclosed is a new nature-based computer for the new Hamiltonian, enabling nature's power in electronic dynamical systems to solve real-valued learning problems with extremely high speed; with experimental results across four real-world applications and six datasets show that NP-GL delivers 6.97×10³ speedup and 10⁵× energy saving with even higher accuracy than GNNs.

In addition to the Ising model, adjustments in the Ising machines are also disclosed. Constructed upon the Ising model, Ising machines specialize in accurately bisecting a group of nodes into two parties with opposite features, putting the effort in maintaining a polarized result. Nevertheless, for the sake of real-valued support, it is favorable to allow the spins to stabilize at intermediate states rather than being exclusively polarized at their boundaries. By implementing this adjustment, the machine is granted the ability to express a wider range of values and is therefore generally applicable in ML.

FIG. 1B is a diagram showing an exemplary workflow of NP-GL, involving Hamiltonian mapping 150, training 160, and inference 170 steps. FIG. 1B shows three essential steps in solving real-world graph learning problems with NP-GL. First, a real-world graph 152 is mapped to the Hamiltonian-based probabilistic graphical model, which is upgraded from the Ising Hamiltonian to support real values. In the model, the nodes 154 are modeled as spins, while the relations between spins, or logical edges, are modeled as coupling and self-reaction parameters J and h. Second, through training with real-valued historical data, an energy landscape 162 is constructed by learning the Hamiltonian parameters, during which the energy ground state is mapped to the maximum likelihood in the model determined by the observed samples. Third, to align with the upgrade of Hamiltonian, slight modifications to a State-Of-The-Art (SOTA) Ising machine are made to build a nature-based computer 172 for NP-GL. After the trained parameters are deployed on the nature-based computer 172, the computer starts to search for the lowest energy state that represents the desired inference results. In some embodiments, an exemplary computing process is as follows: For the known spin values, the spins fixed to the known real-valued data are kept and other spins are allowed to evolve to find the lowest energy state conditioned on the known information. For temporal graph prediction, spins are uniformly divided into multiple partitions, representing the nodes from the previous, current, and future time steps, respectively. The nodes representing the previous and current time steps are fixed to historical data, while the others are predicted by evolving towards the spin configuration with the lowest energy.

The disclosed Hamiltonian addresses three major issues: 1) To solve the spin polarization problem discussed above. 2) To enable effective training techniques. 3) To minimize the adjustment of the backbone hardware. In some embodiments, a pure quadratic term is used to replace the linear term in the Ising Hamiltonian, for example as shown in Equation 5, disclosed in Example 1 herein. Further, to perform real-valued training with affordable computing power, a conditional likelihood method is disclosed for the systems and methods.

The training for Hamiltonian parameters aims to map the energy ground state to the maximum likelihood with real-valued data. It consists of two major components: the conditional likelihood method as the backbone, and two optimization methods to enhance training quality. The disclosed training approach is applicable to both spatial and spatial-temporal models. In the former scenario, the spins only represent the nodes at the same time step, while in the latter case, more spins are necessary to represent the nodes from past, current, and future time steps.

Diagonal Line Reinforcement (DLR): J and h are trained jointly with the training method described above. However, these two types of parameters have distinct physical meanings: coupling and self-reaction. In practice, they also usually differ by orders of magnitude. To differentiate these parameters in training, h is reinforced on the diagonal line of J by multiplying a scaling factor as a hyperparameter. This method is applicable to both spatial and spatial-temporal models. As FIG. 1A illustrates, the diagonal line of J spatial is directly multiplied by the factor to reinforce the self-reaction. Similarly, in a spatial-temporal model, all four submatrices have their individual diagonal lines reinforced, enhancing both the self-reaction and the temporal coupling of the same node.

FIG. 1C is a diagram showing the fine-tuning of a pre-trained spatial model 164. J_{AB}: the coupling between Spin A and B. Spatial Pre-training Coupled with Temporal Fine-tuning: Intuitively, Spin A at time t and t+1 may have similar properties. For instance, they may have similar coupling relations with respect to Spin B, as FIG. 1C shows. Based on this, the temporal couplings may be speculated to have similar values as the spatial couplings. To exploit this property, a spatial model featured as J_{N×N} is pre-trained and mapped onto a spatial-temporal model as initial values. The model is subsequently finetuned to obtain a final model 166. Through this approach, the similarity between spatial and temporal correlations is leveraged, resulting in improved accuracy and convergence speed.

FIG. 1D is a diagram showing the nature-based computer 172 upgraded from its binary predecessor to support real values. In order to harness the power of nature and achieve an end-to-end solution for graph learning, the inference process is carried out on a nature-based computer 172 modified from a SOTA Ising machine to align with the upgrade in the Hamiltonian. The overall layout of the computer is shown in FIG. 1D, in which the nodes 174 are connected through the coupling units 176 in an all-to-all manner.

Specifically, the spin values are represented as the voltage on the capacitors 178 in the nodes, while the parameters J′ and h are represented as conductance. On the right-hand side of the figure, the modifications show that that merely replacing the voltage regulator “ZIV” with a variable resistor 180 in each node imports the quadratic term

$${\sum }_{i} {h}_{i} {V}_{i}^{2}$$

into Hamiltonian. The electric current of Node i is written as equation 10 of example 1, where Jᵢⱼ′ is the effective conductance of the coupling between nodes and 2 hi is the effective conductance of the added variable resistor in the node.

After the Hamiltonian parameters J and h are obtained from training, they are deployed on the nature-based computer 172 for inference. In practice, the spins representing the nodes from the previous and current time steps are fixed to the known data, allowing the spins representing the nodes in future to evolve and reach the spin configuration with the lowest energy, thus performing the prediction.

Further disclosed is a nature-powered graph learning framework dubbed Dynamical System Graph Learning (DS-GL), which transforms the process of solving graph learning problems into the natural annealing process within a parameterized dynamical system embodied as a CMOS chip. To tackle the two major hurdles, DS-GL first augments the Ising machine architecture to modify the self-reaction term of its Hamiltonian function from linear to quadratic, effectively serving as an energy regulator. This adjustment maintains the system's original physical interpretation while enabling it to process continuous, real-valued data. Second, to address the scaling issue, DS-GL further upgrades the real-valued dense Ising machine by decomposing it into a mesh-based multi-PE dynamical system that supports efficient distributed spatial-temporal co-annealing across different PEs through sparse interconnects. By exploiting the inherent sparsity and community structures in real-world graphs, DS-GL is able to map complex graph learning tasks onto the scalable dynamical system while maintaining high accuracy. Evaluations with four diverse GL applications across seven real-world datasets, including traffic flow and COVID-19 prediction, show that DS-GL can deliver from 10³× to 10⁵× speedups over Graph Neural Networks on GPUs while operating at a power 2 orders of magnitude lower than GPUs, with 5%-30% accuracy enhancement.

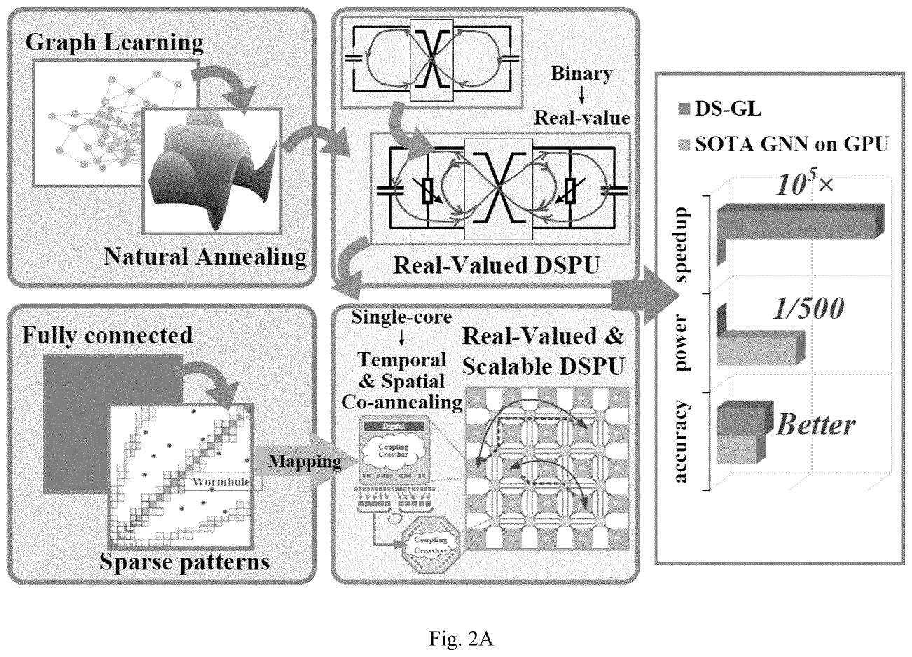

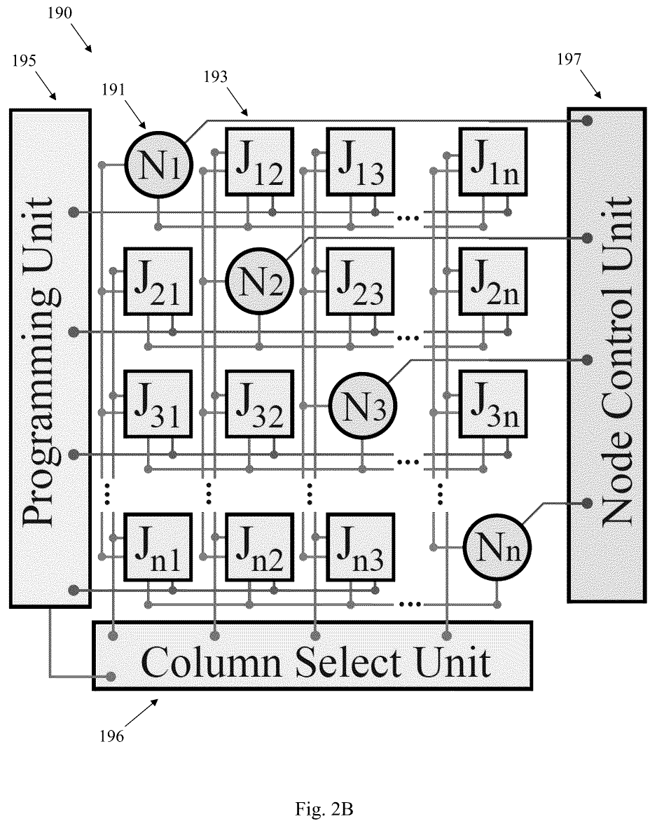

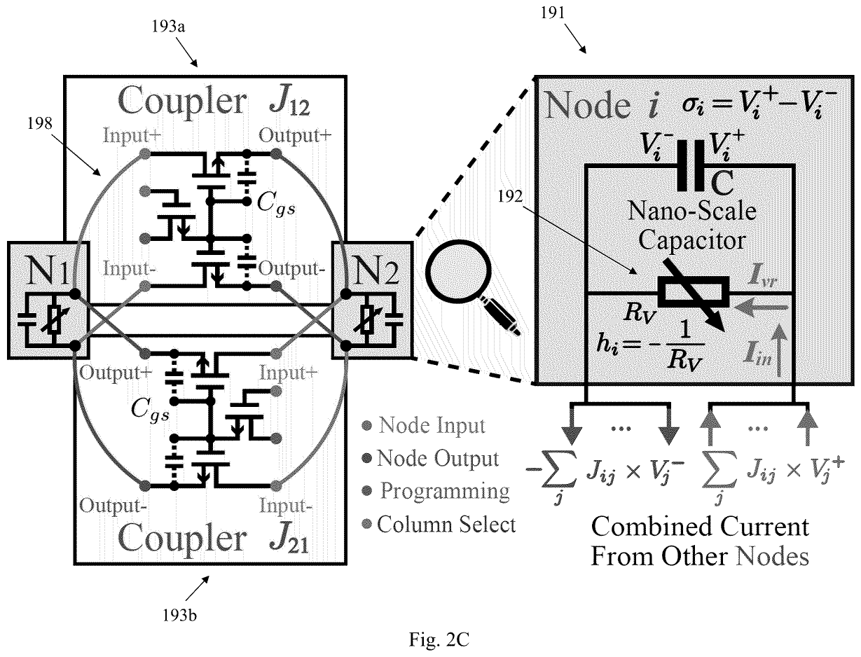

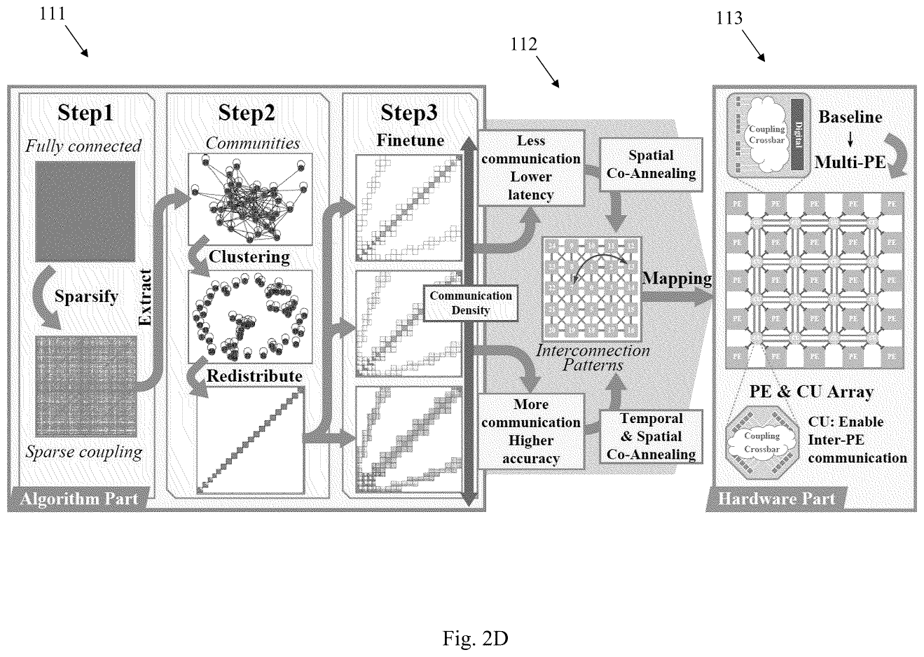

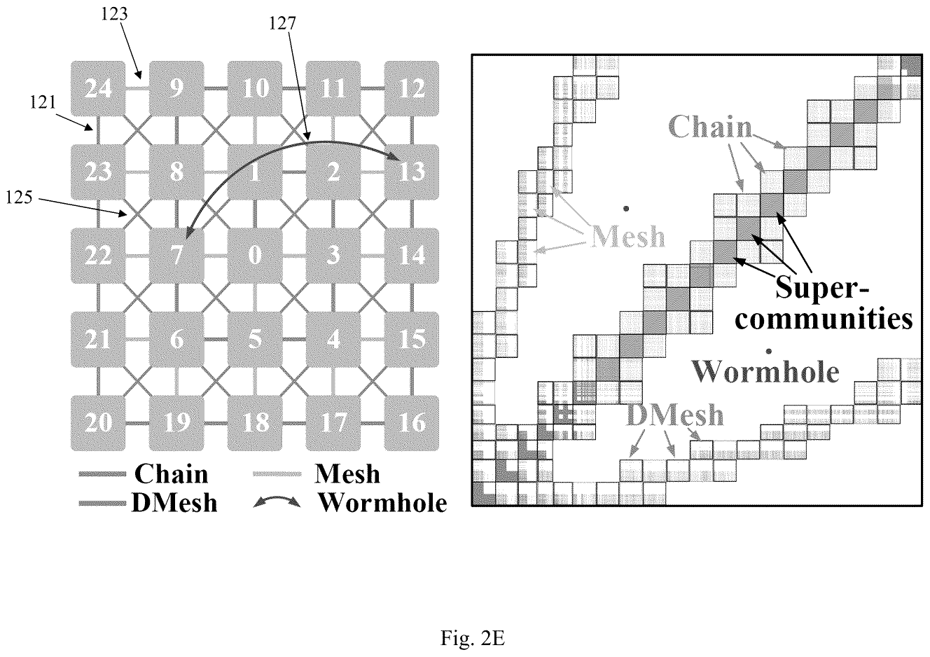

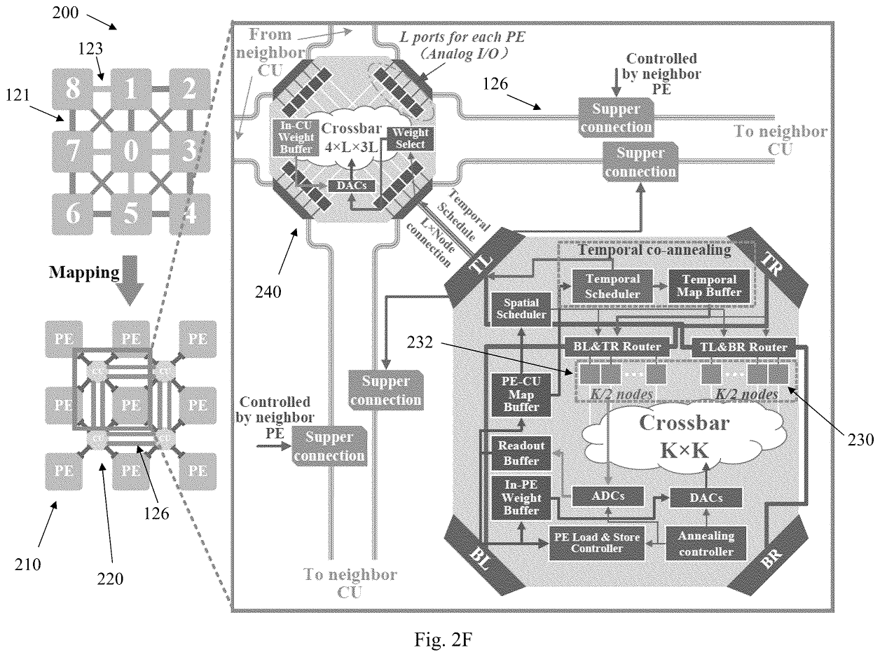

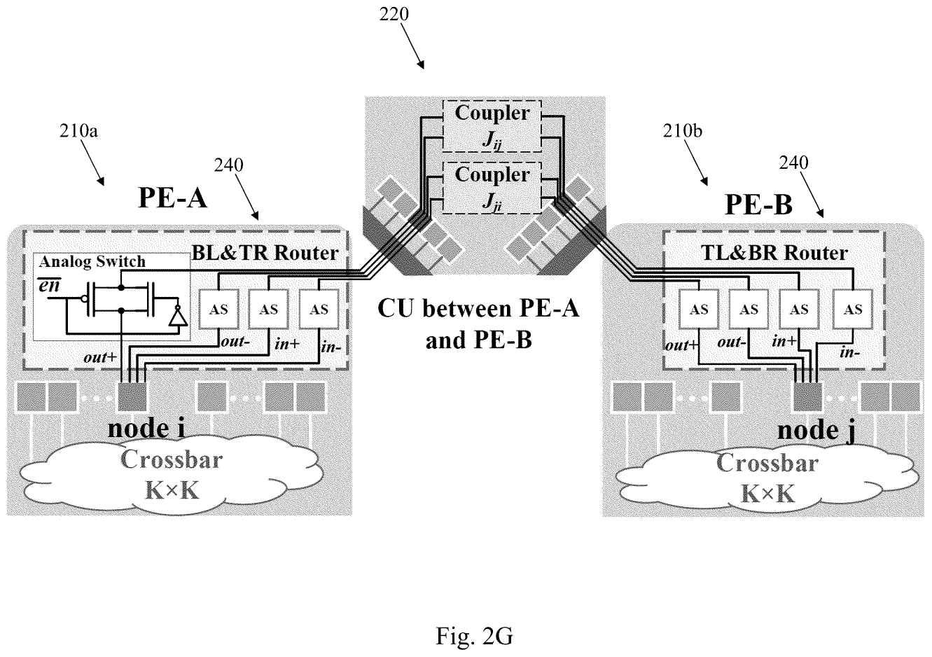

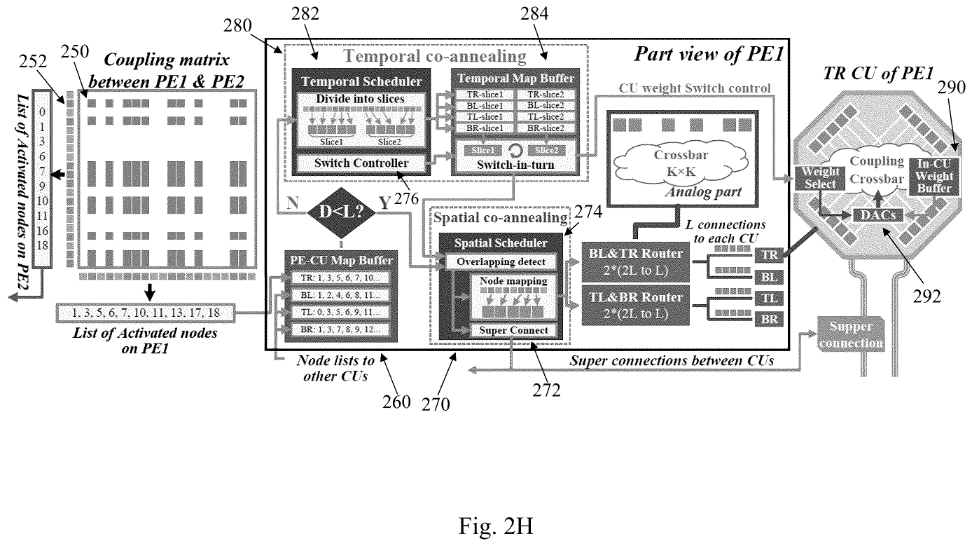

Disclosed herein is a novel Dynamical-System-based Graph Learning framework, DS-GL, which incorporates a real-valued and scalable DSPU coupled with a series of training algorithms for constructing efficient and scalable dynamical systems for GL problems. FIG. 2A is a diagram showing the overview of DS-GL framework and its performance over GNNs. The overview of DS-GL is illustrated in FIG. 2A. Specifically, to enable stable real-valued natural annealing, DS-GL first upgrades the SOTA Ising machine hardware with a circulative resistor ring and the self-reaction term of its corresponding Hamiltonian; then, a training algorithm that accurately configures the system is developed. The algorithm transforms the process of solving GL problems into a process of natural annealing. Coupled with this algorithm, the new “Real-Valued DSPU” can perform real-valued GL with high performance and accuracy. To enhance the scalability, DS-GL further upgrades Real-Valued DSPU into a larger system, dubbed “Scalable DSPU”, with a mesh-based multi-PE architecture that efficiently supports distributed spatial-temporal co-annealing coupled with a learning-based clustering algorithm that can reconstruct dense dynamical systems into the sparse ones with community structures while maintaining high accuracy in natural annealing, Scalable DSPU can solve over 4× larger real-valued GL problems than an Ising machine with only a 30% increase in chip are.

DS-GL is the first work that uses physical dynamical systems and harnesses their intrinsic nature's computational power to solve real-world graph learning problems and outperforms SOTA GNN solutions. Disclosed is a novel nature-powered graph learning framework, DS-GL, that unleashes the inherent computational power of dynamical systems in graph learning; learning-based algorithms that accurately transform the process of solving graph learning problems to the natural annealing process of sparse dynamical systems with a hardware-friendly community structure; and a new dynamic-system-based processing unit, Scalable Dynamical System Processing Unit (DSPU), rooted in a CMOS-compatible Ising machine is disclosed. The scalable DSPU inherits the extraordinary computational efficiency of the Ising machine and extends its potential to real-valued and larger-scale GL problems.

FIG. 2B shows the overview of an exemplary Bistable resistively-coupled Ising machine (BRIM) architecture 190. The values of nodes 191 are represented by the voltages of capacitors in each Nᵢ block. To facilitate all-to-all connection among nodes, BRIM 190 is equipped with a fully-connected coupling network (the network of Jᵢⱼ blocks 193) based on programmable resistors. Therefore, the differences between the voltages of nodes 191 will naturally generate currents among the coupling network to reduce the system energy and push the system towards equilibrium. Programming Units 195 are used to program BRIM by configuring the coupling parameters of the network (i.e., the resistance of the programmable resistors). The couplers are programmed column by column controlled by the Column Select Unit 196. A Node Control Unit 197 is in charge of node value initialization and flipping the binary values of nodes at runtime for effective annealing.

In this context, GL refers to the acquisition of unknown graph node features using observed node features. Taking GNNs for example, node features are obtained by iteratively aggregating features from neighboring nodes. During GL training, the spatial and temporal relations among graph nodes are distilled into a selected model (GNNs or DS-GL), which processes observed node features as its input and generates unknown node features as its output. The model's parameters are adjusted (through backward-propagation in GNNs) according to the discrepancies between the generated outputs and the ground truth. This refinement process allows the model parameters to effectively capture the underlying distribution of the data. During inference, the trained model consumes the observed node features and generates the corresponding unknown node features. Particularly, for temporal prediction tasks, GL uses historical graph information to predict the future states of the graph.

To enable real-value support, modifications applied to the model are introduced, together with Real-Valued DSPU, which incorporates the hardware upgrade to the baseline BRIM to establish the basic hardware components for the disclosed systems and methods. With the model generalized to support real values, the hardware needs enhancements satisfying the following criteria: 1) variables (voltages) must be able to stabilize as real values. 2) the spontaneous decrease in Hamiltonian must be satisfied.

The first criterion is satisfied through the implementation of circulative resistor rings, as depicted in FIG. 2C, which is a diagram showing the real-Valued DSPU architecture. Left: the circulative resistor ring 198, and Right: the detailed node 191 internals for real-value support. This setup incorporates the variable resistor Rv 192 within a node 191 along with the pairwise coupling mechanism (193a, 193b) between nodes 191 to achieve the desired functionality. To accommodate both positive and negative values of J, each pair of nodes 191 is equipped with two circulative resistor rings 198. To meet the second criterion, the dynamics of the variables is designed through Lyapunov analysis, establishing a dynamical system of electrons that can be deployed on hardware.

To provide a complete view of the disclosed work and show how the dynamical system is tamed, the training algorithm here is briefly introduced. The training process aims to obtain a set of parameters J and h that map the desired real-valued result to the lowest energy state, in other words, to construct a data distribution described by a dynamical system. During training, to guarantee the convexity of the Hamiltonian, the parameters h are forced to be negative. Subsequently, the lowest energy state can be obtained by letting the first derivative of the Hamiltonian equal to zero, for example, in Equation 20 shown in Example 2.

With the learned parameters, GL inference can be interpreted as the evolution of the dynamical system. The observed graph nodes are considered as input, while the remaining unknown nodes are taken as output. To initiate the inference process, the input observed nodes are fixed to the observations, as the capacitors are charged and maintained accordingly. Meanwhile, the unknown nodes are randomly initialized. Next, the natural annealing process starts and the system approaches equilibrium, so as to locate a lowest energy state.

FIG. 2D is a diagram showing the workflow of Scalable DS-GL. Blocks labeled 111: algorithm for coupling matrix decomposition. Blocks labeled 112: the architecture of Scalable DSPU. Overview of Scalable DS-GL: Despite the communication effectiveness of all-to-all interactions among nodes, the size of the coupling network increases quadratically with the number of nodes. To address the problem of scalability, the design strategy is to prune links based on the strength of inter-node connections, which refers to the magnitude of coupling parameters. Compared to the weakly coupled nodes, strongly coupled nodes are observed to contribute predominantly to the quality of solution. Considering the fact that real-world graphs are typically extremely sparse with communities composed of strongly-related nodes, it is feasible to only preserve strong connections and relax the weak links between the communities. To accomplish this, as FIG. 2D illustrates, DS-GL is trained as a dynamical system with community structure through three steps: (i) prune the fully connected coupling matrix to a sparse matrix depending on the coupling strength; (ii) extract the communities indicated within the sparse matrix, and group the communities into “super-communities” to match per-DSPU capacity; (iii) further reform the coupling matrix to fit the desired sparse interconnection pattern. To alleviate communication pressure, different super-communities are interconnected through a sparse hierarchy, including Chain, Mesh, DMesh (Diagonally-connected Mesh), and Wormholes (for unavoidable global communication outliers).

On the hardware side, to provide the foundation for scaling, a mesh-based network “Scalable DSPU” is designed as a grid of small DSPUs comprised of Processing Elements (PEs) and Coupling Units (CUs). In essence, each PE serves as a local dynamical system, with neighboring PEs linked through a limited number of analog I/Os via CUs for instantaneous synchronization. In the 2D mesh, communities of nodes are mapped to different DSPUs with their interconnections sparsified into patterns. The patterns are specially designed for efficient “co-annealing” processes upgraded from the annealing concept in Real-Valued DSPU. Furthermore, the co-annealing process is categorized into Spatial co-annealing and Temporal & Spatial co-annealing for different scenarios. Consequently, the scalability of Scalable DSPU is optimized with balanced annealing quality and efficiency.

Training Algorithm for Decomposing Dynamical System. For the disclosed dynamical system, the scalability issue arising from the all-to-all connection can be decomposed into three sub-problems. First, to reduce communication complexity, how to decompose the dynamical system to sparsify the coupling matrix? Second, assuming the coupling is sparse, how to perform computing efficiently? Third, accuracy will drop during the sparsification, how to restore the accuracy? To answer these questions, the solution is also three-fold.
1) Decomposition of the dynamical system. Communities typically exist in real-world graphs as a valuable property. Similar to cliques in graph theory, communities consist of nodes with dense interconnects but with sparse connections to the external nodes. It can be inferred that although more information is embedded in the original all-to-all node interconnection, the majority of the interconnects should be redundant and removable with minimal consequences.

The key is to extract the communities in the target graphs, which is a well-researched topic. In this work, the Louvain algorithm [V. D. Blondel et al., Theory and Experiment, vol. 2008, no. 10, p. P10008, October 2008.] is adopted due to its high efficiency and scalability. To start, the number of non-zero elements (defined as “communication demand density” and annotated as “D” in this work) is limited in the coupling matrix in order to attain an initial sparse coupling matrix for communities extraction. In the next steps, after communities are extracted, they are further sparsified by eliminating weak couplings, drastically reducing the demand for communication bandwidth.
2) Community redistribution. The extracted communities are grouped into super-communities, with each initially distributed to a PE. However, the size of a single community occasionally exceeds the pre-defined hardware capacity of a PE, causing the demand for the community to be further decomposed into smaller sub-communities to fit on hardware. As a consequence, this redistribution process potentially reduces connections within communities, causing accuracy to drop. To make amends, the sub-communities are redistributed onto neighboring super-communities for more communication opportunities. In the meantime, larger communities are granted higher priority to be redistributed. FIG. 2E is a diagram showing the four types of communication patterns. In FIG. 2E (left), for example, assuming that the largest community (or a sub-community of the largest community when it exceeds hardware capacity) fits into super-community 0, it is centered to have more connections with its neighbors. The second largest community is then distributed to super-community 0 if allowed by capacity, otherwise to super-community 1. Finally, for the sake of a balanced workload, smaller communities or isolated nodes are redistributed to fill the blanks left by larger communities on super-communities. Through these redistribution approaches, the locality of communities is exploited with the utilization of a single super-community enhanced.
3) Parameter fine-tune with patterns. With the communities extracted and redistributed, the final problem is addressed—to restore the lost accuracy in these processes. To this end, a fine-tuning process is conducted with constraints to develop a communication-friendly pattern.

To maintain the general coupling matrix pattern obtained from the previous steps, a controlling mask is generated to confine the regions in the coupling matrix where non-zero elements can populate during the fine-tuning process, also eliminating non-zeros outside the region due to the pre-set communication demand density D.

Next, the interconnect pattern of the super-communities is studied. In FIG. 2E (left), four patterns are summarized, which respectively correspond to four types of connections between the super-communities on a 2-D array. FIG. 2E (right) shows the distribution of the patterns in the re-ordered coupling matrix. The links labeled 121 represent the “Chain” type of connections between neighbor super-communities such as 0 and 1. The “Mesh” type of patterns contains all the connections between neighbor super-communities on the 2-D array as links labeled 123 including the one between 0 and 3, as well as all of the “Chain” type of patterns. The links labeled 125 show the additional connections in “DMesh” type of patterns based on “Mesh” which refer to the diagonal connections between super-communities such as 0 and 2. The “Wormhole” 127 in FIG. 2E refers to super-connections over the 2-D array, supporting rare connections between any two super-communities, for example, 7 and 13.

Disclosed Hardware Architecture. The structurally sparse coupling matrix with clustered non-zeros obtained through the decomposition of the dynamical system brings opportunities to achieve efficient and accurate natural annealing with highly sparse dynamical systems. To this end, a scalable DSPU 200 is disclosed, comprising a new dynamical system architecture based on Real-Valued DSPU disclosed herein. FIG. 2F shows the disclosed hardware architecture. The exemplary scalable DSPU 200 is equipped with a 2D array of Processing Elements (PEs) 210. Each PE is a small Real-Valued DSPU with additional buffers, routers, and digital controllers for the support of co-annealing. The PEs 210 are connected to a mesh-based network through configurable Coupling Units (CUs) 220 at the intersection of the mesh. Each CU 220 contains a mini coupling crossbar, which can be reconfigured as different types of connections to bridge nodes from the neighbor PEs 210. During natural annealing, each PE 210 is in charge of the local annealing of a single super-community. Mesh-based interconnect network, together with the configurable CUs 220, builds direct connections for nodes that are from different PEs 210 but with non-zero coupling parameters. During annealing, voltage differences across node pairs drive currents across different PEs 210, enabling “Spatial co-annealing”. When the number of nodes in a PE 210 that need to communicate with external nodes exceeds the limited input/output capacity of this PE 210, these nodes will occupy the I/O in a time division multiplexing manner, which is scheduled collaboratively by their PE 210 and the corresponding CUs 220, enabling the Temporal & Spatial co-annealing. In the following, the architecture design of each major super-community in Scalable DSPU 200 is elaborated on in detail.

PE architecture: As shown in FIG. 2F, each PE 210 contains K nodes (blocks connected to Routers labeled 230, 232 respectively). All nodes are fully connected through an internal KxK crossbar coupling network, like in Real-Valued DSPU. Different from Real-Valued DSPU, the nodes are divided into two partitions. Each partition contains k/2 nodes and is connected to either Bottom-Left (BL) & Top-Right (TR) routers or Top-Left (TL) & Bottom-Right (BR) routers. Each router, jointly controlled by Spatial and Temporal Schedulers, is able to route its own share of nodes to its corresponding two neighboring CUs 220 through analog-based exporting portals at the four corners of the Pes 210. The Spatial Scheduler selects the nodes that need to be connected with external PEs 210 and supervises the corresponding Router to allocate I/O resources at one of the selected exporting portals for the nodes. This builds the foundation of Spatial co-annealing. The Temporal Scheduler is in charge of selecting nodes for temporal co-annealing when the number of nodes that need to communicate with external PEs 210 exceeds the I/O resources (L lanes within each portal) at the exporting portals. Each PE is also equipped with several banks of buffers that cache the communication mapping information generated during training.

CU architecture: CU is at the intersection of the mesh-based network and is used to connect PEs to the network. The coupling parameters in a CU are stored locally in the In-CU Weight Buffer controlled by the Weight Select module. Similarly to PEs, each CU has four exporting portals which connect the CU with four PEs. To align the communication bandwidths of CUs and PEs, each portal in a CU is also equipped with L lanes of connection. Therefore, each CU can be connected with 4L nodes in four neighboring PEs simultaneously. Each CU is equipped with a 4L×3L crossbar 240 connecting all pairs of nodes in different PEs. Note that a CU does not need a 4L×4L full-size crossbar as the nodes from the same PE are already fully connected locally. With nodes from different PEs directly connected within CUs, their Spatial co-annealing is enabled. Here, the number of lanes in each portal of both CU and PE (L) is defined as hardware communication capability. In the evaluation, L is set as 30 for better performance and hardware tradeoff.

Interconnect Architecture: The interconnect architecture of Scalable DS-GL is composed of two parts: 1) the connections between exporting portals of CUs and PEs together compose a tiled mesh-based interconnect (the links labeled 121 in FIG. 2F); and 2) the super connections (lines labeled 126) that connect exporting portals of neighboring CUs compose another grid-based interconnect (the links labeled 129 in FIG. 2F). As aforementioned, the links labeled 121 enable the Spatial co-annealing among nodes from neighboring PEs. In contrast, the links labeled 123 enable the co-annealing among nodes from remote PEs. From the perspective of the coupling matrix, the scattered non-zeros located in the blank space require remote communication in pursuit of efficient and accurate annealing and therefore require “Wormholes” (as shown labeled as 127 in FIG. 2E). To open a Wormhole for two nodes from remote PEs, the corresponding PEs first map both nodes to their neighboring CUs and then enable the super connections in the route between the two CUs.

Analog I/O Details: FIG. 2G shows the signal channel between two nodes from different PEs (210a, 210b) containing two high-speed analog switches and an analog resistive component, i.e., CU coupling unit. In each PE 210, a router 240 selects the corresponding analog switches to establish analog connections between nodes in the PEs 210 and ports on the CU 220, thereby enabling the inter-PE communication via the analog coupling crossbar in CUs. This analog-fashioned connection avoids extra A/D or D/A conversion and fully supports heterogeneous interconnect patterns in FIG. 2E, leveraging the flexibility of analog coupling crossbars in CUs and routers in PEs. As shown in FIG. 2F, each node in a PE 210 can be connected to up to 4 neighbor CUs 220. Within each CU, a node is further connected to up to 90 nodes from 3 neighboring PEs through the coupling network.

Challenge in decomposing large-scale graphs: With DSGL, graphs can be decomposed more aggressively without sacrificing accuracy than GNNs. The underlying reasons are two-fold. First, as an electronic dynamical system, DS-GL hardware constantly propagates node information to their directly connected neighbors through the movement of electrons (flow of electric current) among capacitors, facilitating fast and long-range cascading information propagation among remotely connected nodes. Therefore, with DS-GL, information can be seamlessly transmitted even among nodes that are not directly connected. This feature is distinguished from GNNs, where information is propagated from one node to its neighbors for only once per layer. Second, for nodes in the clusters that are not directly connected through CUs, if their connections are critical for high accuracy, the Wormhole interconnection introduced above will be enabled to establish direct connections among them. It is worth highlighting that the “Wormholes” require no extra hardware, but only share little resources from CUs to enable direct connections among remote PEs with considerable bandwidth.

Featuring Co-Annealing Methods. Since the disclosed sparse dynamical system is no longer fully connected, the natural annealing process in a Real-Valued DSPU should be adjusted accordingly. In particular, two imperative problems are confronted. First, in contrast to the all-to-all connections in a Real-Valued DSPU, what modifications are required in the hardware to make the PEs collaboratively anneal through the sparse connections? Second, how can the hardware manage situations where its capacity is inadequate to facilitate the concurrent annealing of all nodes? In response to these problems, the co-annealing approaches are also categorized in a bipartite manner. (a) Spatial co-annealing is the standard annealing process performed on the disclosed sparse dynamical system. Given the communication patterns of the super-communities, natural annealing is collectively performed in all super-communities leveraging the disclosed hierarchical interconnect architecture. (b) Temporal & Spatial co-annealing is designed in the case of insufficient capacity of the dynamical system. In this scenario, one Spatial co-annealing is transformed into iterative partial annealing until convergence is reached.

Spatial co-annealing method: FIG. 2H depicts the coupling between two example PEs on the left, demonstrating the sparse communication pattern between nodes. The squares labeled 250 denote the communication facilitated between the nodes depicted as squares labeled 252, aka “activated nodes”. Subsequently, annealing is performed following the communication pattern as Spatial co-annealing, featuring its real-time synchronization capability through CUs. In the framed box centered in FIG. 2H, taking PE1 for example, the Spatial co-annealing mechanism starts from a “PE-CU Map Buffer” 260 which stores all the lists of activated nodes to be deployed to neighbor CUs. For a hardware configuration with specific L, the mapping method is further selected depending on whether D is less than L. If yes, the Spatial co-annealing method shown in box 270 with dotted frame is applied. In this situation, the spatial scheduler directly fetches the node-to-CU mapping information from “PE-CU Map Buffer” 260. It first detects the overlapping between the nodes to different CUs, and then generates the mapping signal to the routers. Meanwhile, the “Super Connect” module 272 sends a control signal to enable communication between CUs for overlapped nodes or “Wormhole” patterns. Since the communication demand density is lower than the hardware communication capability, all nodes can be directly mapped to the corresponding CUs. The TR CU of PE1 is drawn in the figure as an example, where the weights (or the coupling parameters) for the couplings in the CU are stored locally in the “In-CU Weight Buffer” 290 in each CU. For Spatial co-annealing, the weights do not change and are programmed to the coupling crossbar via DACs 292.

Temporal & Spatial co-annealing method: In the high communication demand density scenario, when D is greater than L, the CUs become saturated with some unaddressed couplings, and the standard Spatial co-annealing no longer applies. Under this circumstance, a Temporal & Spatial co-annealing approach is adopted, with a single Spatial co-annealing decomposed into iterations of partial annealing. In FIG. 2H, the box labeled 280 with dotted frame shows the hardware for the Temporal co-annealing component, which functions collectively with the Spatial co-annealing part as follows. First, the node lists from the “PE-CU Map Buffer” 260 are sent to the temporal scheduler 282 to divide the lists into smaller “slices”, with each size not greater than L. The slices are then stored in the “Temporal Map Buffer” 284, where the buffer sends only one group of slices at a time to the spatial scheduler 274 for further spatial mapping. The “Switch Controller” 276 generates the control signals to inform the buffer 284 to exchange the groups of slices in turn, namely, a Switch-in-turn process. Since the weight parameters in a CU need to be exchanged within different slices, the switch control signals are also connected to the “Weight Select” module in the CU. In this way, high communication demand is supported by the disclosed hardware architecture, even with limited capacity of CUs.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

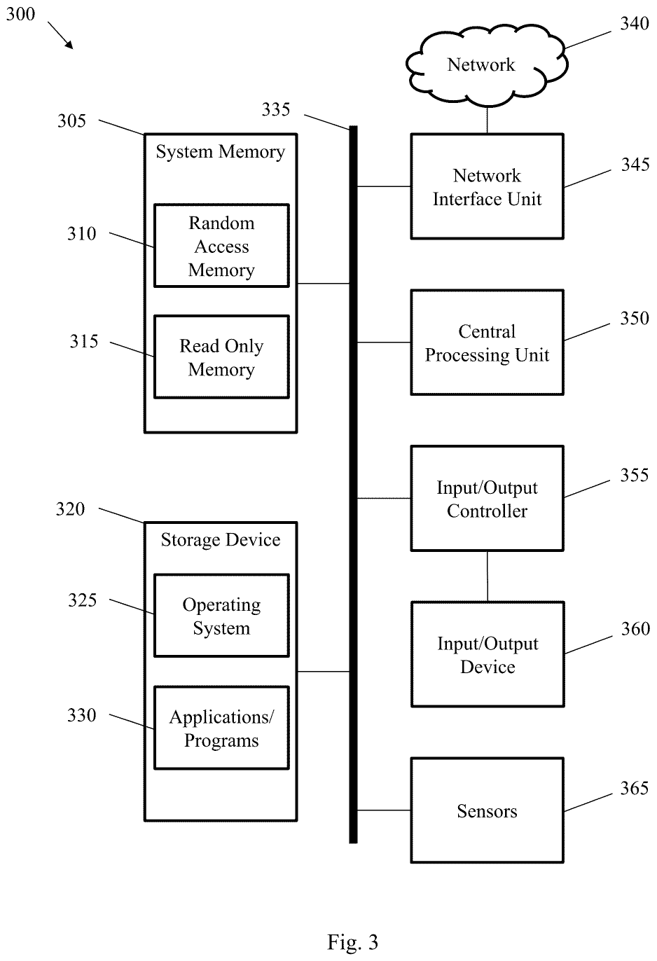

FIG. 3 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 3 depicts an illustrative computer architecture for a computer 300 for practicing the various embodiments of the invention. The computer architecture shown in FIG. 3 illustrates a conventional personal computer, including a central processing unit 350 (“CPU”), a system memory 305, including a random access memory 310 (“RAM”) and a read-only memory (“ROM”) 315, and a system bus 335 that couples the system memory 305 to the CPU 350. A basic input/output system containing the basic routines that help to transfer information between elements within the computer, such as during startup, is stored in the ROM 315. The computer 300 further includes a storage device 320 for storing an operating system 325, application/program 330, and data.

The storage device 320 is connected to the CPU 350 through a storage controller (not shown) connected to the bus 335. The storage device 320 and its associated computer-readable media provide non-volatile storage for the computer 300. Although the description of computer-readable media contained herein refers to a storage device, such as a hard disk or CD-ROM drive, it should be appreciated by those skilled in the art that computer-readable media can be any available media that can be accessed by the computer 300.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 300 may operate in a networked environment using logical connections to remote computers through a network 340, such as TCP/IP network such as the Internet or an intranet. The computer 300 may connect to the network 340 through a network interface unit 345 connected to the bus 335. It should be appreciated that the network interface unit 345 may also be utilized to connect to other types of networks and remote computer systems.

The computer 300 may also include an input/output controller 355 for receiving and processing input from a number of input/output devices 360, including a keyboard, a mouse, a touchscreen, a camera, a microphone, a controller, a joystick, or other type of input device. Similarly, the input/output controller 355 may provide output to a display screen, a printer, a speaker, or other type of output device. The computer 300 can connect to the input/output device 360 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 320 and/or RAM 310 of the computer 300, including an operating system 325 suitable for controlling the operation of a networked computer. The storage device 320 and RAM 310 may also store one or more applications/programs 330. In particular, the storage device 320 and RAM 310 may store an application/program 330 for providing a variety of functionalities to a user. For instance, the application/program 330 may comprise many types of programs such as a word processing application, a spreadsheet application, a desktop publishing application, a database application, a gaming application, internet browsing application, electronic mail application, messaging application, and the like. According to an embodiment of the present invention, the application/program 330 comprises a multiple functionality software application for providing word processing functionality, slide presentation functionality, spreadsheet functionality, database functionality and the like.

The computer 300 in some embodiments can include a variety of sensors 365 for monitoring the environment surrounding and the environment internal to the computer 300. These sensors 365 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

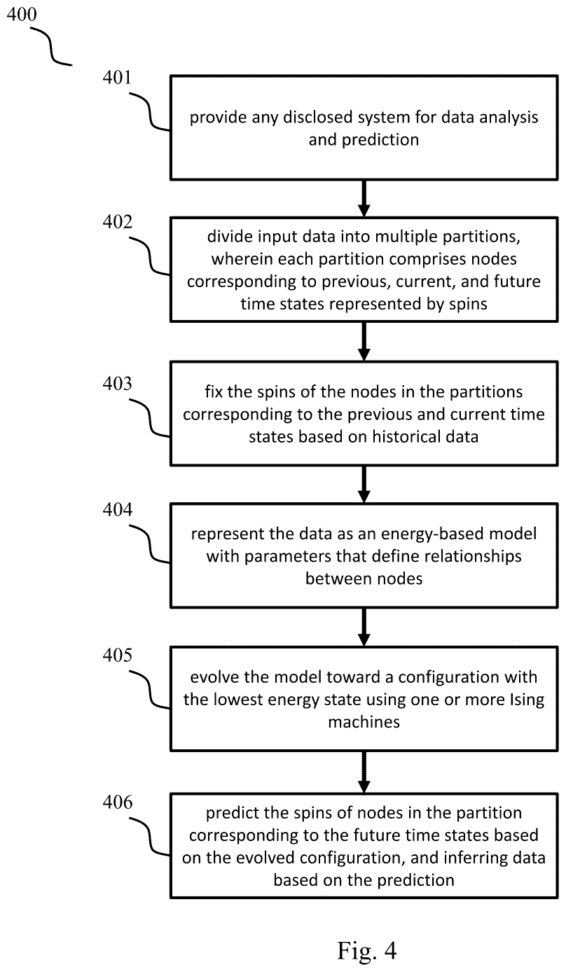

FIG. 4 is a diagram depicting an exemplary method for data analysis and prediction. In some embodiments, a method 400 for data analysis and prediction comprises: 401 providing any disclosed system for data analysis and prediction, 402 dividing input data into multiple partitions, wherein each partition comprises nodes corresponding to previous, current, and future time states represented by spins; 403 fixing the spins of the nodes in the partitions corresponding to the previous and current time states based on historical data; 404 representing the data as an energy-based model with parameters that define relationships between nodes; 405 evolving the model toward a configuration with the lowest energy state using one or more Ising machines; and 406 predicting the spins of nodes in the partition corresponding to the future time states based on the evolved configuration, and inferring data based on the predictions.

A method for real-world graph learning, comprising the steps of providing a computing device comprising one or more modified Ising machines; mapping a real-world graph to a Hamiltonian-based probabilistic graphical model that supports real values; training the model with the Hamiltonian parameters and real-valued historical data; constructing an energy landscape based on the trained model, wherein an energy ground state is mapped to the maximum likelihood in the model; searching for the lowest energy states of the model, wherein the lowest energy states represent desired inference results. In some embodiments, the Ising machine undertakes a process of electron-speed annealing with asynchronous spin flipping. In some embodiments, the spins are allowed to stabilize at intermediate states. In some embodiments, the coupling parameters in the Ising Hamiltonian are trained to map the desired results of a given ML problem to the lowest-energy states.

In some embodiments, for known spin values, the spins fixed to the known real-valued data are kept and other spins are allowed to evolve to find the lowest energy state conditioned on the known information. In some embodiments, for temporal graph prediction, spins are uniformly divided into multiple partitions, representing the nodes from the previous, current, and future time steps. In some embodiments, the nodes representing the previous and current time steps are fixed to historical data, while the others are predicted by evolving towards the spin configuration with the lowest energy. In some embodiments, coupling parameters in the Ising Hamiltonian can be trained to effectively map the desired results of a given ML problem to the lowest-energy states.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### Example 1: Extending Power of Nature from Binary to Real-Valued Graph Learning in Real World

This example aims to unleash this pathway by proposing a novel end-to-end Nature-Powered Graph Learning (NP-GL) framework. Specifically, through a three-dimensional codesign, NP-GL can leverage the spontaneous energy decrease in nature to efficiently solve real-valued graph learning problems. Experimental results across 4 real-world applications with 6 datasets demonstrate that NP-GL delivers, on average, 6.97× 10³ speedup and 10⁵ energy consumption reduction with comparable or even higher accuracy than Graph Neural Networks (GNNs).

Nature apparently performs complex computations constantly, e.g., solving differential equations and performing random sampling, at clearly lower cost and higher performance than digital computers. Nature's computation can be powered by various phenomena in physics: entanglement and tunneling that drive quantum computing, the spontaneous energy decrease observed in dynamical systems that drives energy-based computing, and so on.

The latter happens ubiquitously in daily life-actually, many dynamical systems in nature spontaneously and swiftly evolve towards the most stable states with the lowest energy, during which highly complex computation is performed. Intuitive examples are ink diffusion in water and chemical reactions among molecules. These natural processes are extremely complex—to be evaluated with acceptable accuracy on digital computers, chemical reactions, such as drastic combustion processes involving only 100K atoms, can be formulated as over 10⁷ iterations of computation with each iteration requiring 10⁹ FLOPs (Wu et al., 2023). In contrast, nature can deliver accurate solutions to such complex problems within microseconds. Disclosed in this example are computers that can efficiently harness the power of nature, these computers, so-called “nature-based computers”, that can solve complex real-world learning problems delivering substantial speedups and competitive accuracy compared with traditional solutions e.g., NNs on GPUs.

Intrigued by the unique computational power in nature, in the past decade, besides the tireless efforts on the development of NNs, the community has also relentlessly explored ML paradigms that are powered by natural principles and can be realized on nature-based computers. Typical examples are quantum ML (King et al., 2022) on quantum computers and optical ML on photonic or optical systems (Inagaki et al., 2016b; Lin et al., 2018). Regrettably, despite their perceived potential, many nature-powered ML methods are still predominantly theoretical and demand stringent operational conditions. Notably, the emergence of the “Ising machine” (Afoakwa et al., 2021; Sharma et al., 2022) is closing the gap between theoretical nature-powered methodologies and practical applications. This computing paradigm, compatible with CMOS technology, can operate at room temperature with less than 1 Watt of power consumption, signifying a major leap towards unleashing the computational power of nature into the real world.

FIG. 1A is a diagram showing an overview of an exemplary end-to-end NP-GL framework.

Specifically, Ising machines as a physical embodiment of the Ising model can be thought of as a dynamical system governed by the Hamiltonian (energy function of a dynamical system) of the Ising model. Driven by the spontaneous energy decrease in nature, a CMOS-based Ising machine can swiftly and automatically chase and find its lowest-energy states at the “speed of electrons” with negligible costs-mW power & ns latency. Unsurprisingly, the unique computational power of Ising machines has enabled a new nature-powered ML paradigm-termed “Ising Graph Learning (IGL)” in this example. In IGL, a graph problem (e.g., time series forecasting) is formulated as an Ising model whose parameters are trained to map the problem's desired (e.g., prediction) results with higher probabilities to the lower energy states of the Ising machine, enabling the Ising machine to automatically find the desired solution at extreme speed. It has been demonstrated that IGL outperforms GNNs with orders of magnitude speedups maintaining competitive accuracy in simple real-world graph learning applications with binary data, e.g., traffic congestion prediction (Pan et al., 2023) and collaborative filtering (Liu et al., 2023).

Despite the early-stage successes, a significant limitation persists within Ising Graph Learning: it only works with binary problems. The limitation is rooted in the definition of the Ising model—a node (aka “spin”) of the Ising model has only two states. As the physical implementation of the Ising model, Ising machines are also designed for binary objects. Regrettably, as most critical applications in the real world use real-valued data, the practical values of IGL remain highly limited. As discussed herein, the notable advantages of Ising Graph Learning, driven by the automatic energy decrease, can be extended to the real number field, the ensuing nature-powered graph learning paradigm offering orders of magnitude speedups and energy savings compared to GNNs while preserving highly competitive accuracy for graph learning problems.

To this end, this example comprises an end-to-end Nature-Powered Graph Learning (NP-GL) framework, extending nature's computing power inherent in dynamical systems to tackle real-valued and real-world graph learning problems. The framework's overview, encompassing four components, is depicted in FIG. 1A: Limitation analysis of Ising Graph Learning: Why the vanilla Ising Graph Learning (including both the Ising model and Ising machine) cannot be straightforwardly extended to support real values without upgrading the Ising Hamiltonian was theoretically analyzed. Exploration of NP-GL Hamiltonian: Based on the analysis, NP-GL incorporates a newly designed Hamiltonian that is highly hardware-friendly. It inherits the strengths of the Ising model, ensuring high expressivity, and maintains distinct stable states with real values. Design of NP-GL training algorithms: Similarly to Ising Graph Learning, the parameters of the new Hamiltonian were trained to construct an energy landscape, in which the lowest-energy states correspond to the ground truth derived from historical data. In pursuit of high accuracy, NP-GL training adopts an improved conditional likelihood method with two optimizations: 1) Diagonal Line Reinforcement, which reinforces the self-reaction parameters for better temporal continuity and differentiates the training of self-reaction (diagonal) and coupling parameters that convey distinct physical information. 2) Spatial Pre-training coupled with Temporal Fine-tuning, which leverages the similarity between spatial and temporal correlations to better learn from the temporal information. Design of NP-GL nature-based computer: Due to the similarity between NP-GL and Ising Hamiltonians, the new nature-based computer governed by the NP-GL Hamiltonian was built by slightly augmenting the circuitry of the Ising machine. The new nature-based computer, like Ising machines, leverages nature's power to swiftly find the lowest-energy states, but, unlike them, it does so with real values.

NP-GL is the first end-to-end real-valued nature-powered ML solution that outperforms NNs in the real world. Disclosed is NP-GL, an end-to-end nature-powered graph learning system and method, through codesign of Hamiltonian, training algorithms, and nature-based hardware. NP-GL lifts the binary limitation of existing nature-powered ML methods and extends their applicability to real-valued problems by designing a new hardware-friendly Hamiltonian for real-valued support, coupled with an efficient training method with two optimizations that ensure high training speed and quality. Also disclosed is a new nature-based computer for the new Hamiltonian, enabling nature's power in electronic dynamical systems to solve real-valued learning problems with extremely high speed. The experimental results across four real-world applications and six datasets show that NP-GL delivers 6.97×10³ speedup and 10⁵× energy saving with even higher accuracy than GNNs.

ISING MODEL AND ISING MACHINE: The Ising model is a probabilistic graphical model rooted in the statistical physics of ferromagnetism and widely employed to represent complex dynamical systems. Its Hamiltonian is as follows:

$${ℋ}_{I sing} = {\sum }_{i \neq j}^{N} {J}_{i j} {σ}_{i} {σ}_{j} - {\sum }_{i}^{N} {h}_{i} {σ}_{i} ; {σ}_{i} ∈ \{ - 1 , + 1 \} \qquad Equation 1$$

Due to magnetic physical property, an Ising spin σᵢ has two states “+1” and “−1”, namely, spin up and spin down. Jᵢⱼ is the coupling parameter representing the spatial and temporal correlations among different spins; hᵢ represents the self-reaction strength to the external impact and provides temporal continuity for time-series problems. The generalized Ising model goes beyond physical lattices and uses complete graphs to embed all-to-all correlations among spins, therefore exhibiting strong connectivity, expressivity, and the long-range cascading ability to propagate information. A graph can be straightforwardly mapped to an Ising model, where the nodes are modeled as spins σ, and edges as a pair-wise coupling coefficient matrix Jᵢⱼ and the self-reaction hᵢ of individual spins. In the realm of graph learning, these properties are exceptionally valuable for accuracy.

Variations of the Ising model: A few other models are related to the (vanilla) Ising model. The quantum Ising model allows spins to be in a state that is a superposition of up and down, incorporating quantum effects. It is used mostly for the study for quantum phase transitions (Kadowaki & Nishimori, 1998; Dziarmaga, 2005; Chakrabarti et al., 2008) and quantum magnetism (Labuhn et al., 2016; Schauß et al., 2015; Bitko et al., 1996). The XY model and the Heisenberg model extra degrees of freedom for spins so that they are unit vectors in the 2D and 3D spaces, respectively. The former is usually used to study topological phase transitions (Leoncini et al., 1998; Song & Zhang, 2021), and also acts as the model foundation for electronic oscillator-based Ising machines. The Heisenberg model allows spins to orient in three spatial dimensions, making it crucial for studying magnetism in certain materials (Fisher, 1964; Arnesen et al., 2001), while its 3D spin orientation significantly increases the model complexity. In spite of the number of Ising model variations, they largely remain theoretical with few practical realizations, as even realizing the vanilla Ising model is very challenging (as discussed in (Afoakwa et al., 2021)). Reasonably, it is vital to preserve the feature of easy manufacturing when adding real-value support to the Ising model.

Ising machine, as a physical embodiment of the Ising model (Cipra, 1987), can be thought of as a dynamical system whose gradient is the Ising Hamiltonian. The inherent nature of gradient dynamical systems is to seek the lowest-energy or most probable states. Like other dynamical systems, the Ising machine also naturally gravitates towards the lowest-energy state. What powers this inclination of the Ising machine to find the lowest-energy states is inherently derived from nature, more specifically, the spontaneous energy decrease in nature. To show some Ising machine examples, three prominent technologies are listed, including D-Wave's quantum annealers (Harris et al., 2010), Coherent Ising Machines (CIMs) (Inagaki et al., 2016a), and coupled oscillators (Wang & Roychowdhury, 2019). D-Wave's system takes advantage of quantum effects with its superconducting qubits, but also faces constraints in problem mapping and high power consumption due to cryogenic operational requirements. CIMs use Optical Parametric Oscillators, enabling simpler, all-to-all spin coupling, but are challenged by scalability and temperature stability issues, as well as heavy computational demands for pulse modulation. In addition, emerging oscillator-based Ising machines, which form stable phase relationships and utilize LC tank oscillators suitable for analog circuits, face challenges in the oversized machine and the lack of high quality inductors. On the other hand, the Ising machine used as the backbone of the disclosed NP-GL nature-based computer is BRIM (Afoakwa et al., 2021), the current State-Of-The-Art (SOTA). As discussed earlier, considering the difficulty in realizing the Ising models, even the vanilla model, the practicality of deployment becomes exceptionally important. Fortunately, BRIM is constructed to operate at room temperature using low-power circuits and in standard CMOS technology, inheriting decades of manufacturing experience. In such Ising machine, the states of objects, aka “spins”, are effectively modeled as nano-scale capacitors and the coupling parameters representing the correlations among objects are modeled as resistors of varying resistance. Specifically, the electrons automatically traverse between capacitors through wires connected to resistors to establish a stable electric charge distribution, enabling the “speed of electrons”. Consequently, the overall energy is minimized, and the lowest-energy state solution is found with extremely low operating latency. It is not hard to imagine that if the coupling parameters in the Ising Hamiltonian can be trained to effectively map the desired results of a given ML problem to the lowest-energy states, the Ising machine can then perform nanosecond-scale nature-powered ML inference and find the expected results.

ISING GRAPH LEARNING: BINARY GRAPH LEARNING BASED ON ISING MACHINE: When it comes to solving a graph learning problem using an Ising machine, two steps are encompassed. Firstly, the complete correlation graph is trained to construct an energy landscape, in which the energy ground state of the Ising model corresponds to the ground truth derived from historical data pertaining to the problem. Secondly, upon initializing the spins, the Ising machine undertakes a process of electron-speed annealing with asynchronous spin flipping, enabling it to efficiently converge towards the energy ground state that accurately represents the problem's ground truth. In essence, the computation is carried out by nature itself, resulting in an exceptionally rapid computational process. Recent studies have demonstrated that Ising Graph Learning outperforms GNN in binary problems. However, this new ML paradigm only works with binary problems.

GRAPH NEURAL NETWORKS. GNNs represent a class of models designed to address graph-structured data, which are prevalent across diverse domains, including physics (Shlomi et al., 2020), social science (Yang et al., 2021), bioinformatics (Yi et al., 2021), combinatorial optimization (LIU, 2022) and so on. GNNs effectively learn graph embeddings by iteratively propagating information between connected nodes in a graph. They usually employ a message-passing mechanism, where each node aggregates and updates information from its neighbors, allowing the network to capture complex relational patterns within the graph. These learned embeddings contain valuable insights about the graph, making GNNs a powerful tool (Xu et al., 2018; Zhou et al., 2020) for various graph-related tasks such as node classification (Kipf & Welling, 2016; Jiang & Luo, 2022), link prediction (Zhang & Chen, 2018; Chen et al., 2022), and graph classification (Wu et al., 2019a).

MOTIVATION: THEORETICAL ANALYSIS OF THE BINARY LIMITATION. This section theoretically examines the inherent binary limitation of the Ising model. Specifically, it demonstrates that the direct replacement of binary variables of the Ising Hamiltonian with real-valued ones without modifying the Hamiltonian formulation (namely, “naive real-valued Ising model”) will result in an energy landscape without local energy minima. Consequently, this model lacks the necessary expressivity to solve real-valued ML problems. The stationary points of the naive real-valued Ising Hamiltonian are obtained by solving the below equation for N spins, with σᵢ∈R being the only difference from H Ising.

$$\frac{\partial {ℋ}_{Ising}^{R}}{\partial {σ}_{i}} = - {\sum }_{i \neq j}^{N} ( {J}_{i j} + {J}_{j i} ) {σ}_{j} - {h}_{i} = 0 \qquad Equation 2$$

which can be formulated into the following vector form:

$$\begin{matrix}- {J}^{′} σ = h ; & diag ( {J}^{′} ) = 0\end{matrix} \qquad Equation 3$$

where J′=J+J^{T}. For stationary point analysis, the Hessian Matrix of

$${ℋ}_{Ising}^{R}$$

is computed.

$$ℋ ( {ℋ}_{Ising}^{R} ) = - {J}^{′} \qquad Equation 4$$

Because J′ is a constant matrix, all stationary points have the same concavity. J′ is also diagonalizable due to its symmetry. Therefore, based on the theorem in linear algebra,

$$tr ( {J}^{′} ) = {\sum }_{i}^{N} {λ}_{i}$$

where λᵢ is the i'th eigenvalue of J′. As the diagonal line of J′ is 0, both positive and negative eigenvalues exist unless J′=0_{N×N}. This suggests that all the stationary points are saddle points instead of local minima, indicating that there are always neighbor states with lower energy and therefore no local minima can be found by the Ising machine. In practice, as both the energy of the Ising model and the values of the spins in the Ising model have boundaries (e.g., +1 and −1 for the spins), the Ising machine always stops at the boundary energy state with highly polarized spin values. If used in ML, these spin values are uninformative, normally representing inaccurate results. To this end, the Hamiltonian must be upgraded to support real values.

In addition to the Ising model, adjustments in the Ising machines are also desired. Constructed upon the Ising model, Ising machines specialize in accurately bisecting a group of nodes into two parties with opposite features, putting the effort in maintaining a polarized result. Nevertheless, for the sake of real-valued support, it is favorable to allow the spins to stabilize at intermediate states rather than being exclusively polarized at their boundaries. By implementing this adjustment, the machine is granted the ability to express a wider range of values and is therefore generally applicable in ML.

To bring the nature power to the realm of real values, the binary limitations were broken by developing the NP-GL framework, which is described in depth herein.

THE DISCLOSED NP-GL FRAMEWORK. This section introduces the details of the disclosed NP-GL framework. An overview of NP-GL workflow is provided, and then step-by-step the design of NP-GL Hamiltonian, training algorithm, and nature-based hardware architecture are presented herein.

OVERVIEW OF NP-GL. FIG. 1B is a diagram showing the workflow of NP-GL, involving Hamiltonian mapping, training, and inference steps. FIG. 1B shows three essential steps in solving real-world graph learning problems with NP-GL. First, a real-world graph is mapped to the Hamiltonian-based probabilistic graphical model, which is upgraded from the Ising Hamiltonian to support real values. In the model, the nodes are modeled as spins, while the relations between spins, or logical edges, are modeled as coupling and self-reaction parameters J and h. Second, through training with real-valued historical data, an energy landscape is constructed by learning the Hamiltonian parameters, during which the energy ground state is mapped to the maximum likelihood in the model determined by the observed samples. Third, to align with the upgrade of Hamiltonian, slight modifications to a SOTA Ising machine are made to build a nature-based computer for NP-GL. After the trained parameters are deployed on the nature-based computer, the computer starts to search for the lowest energy state that represents the desired inference results. The specific computing process is as follows: For the known spin values, the spins fixed to the known real-valued data are kept and other spins are allowed to evolve to find the lowest energy state conditioned on the known information. For temporal graph prediction, spins are uniformly divided into multiple partitions, representing the nodes from the previous, current, and future time steps, respectively. The nodes representing the previous and current time steps are fixed to historical data, while the others are predicted by evolving towards the spin configuration with the lowest energy.

THE DISCLOSED HAMILTONIAN. A Hamiltonian is disclosed for three major reasons. 1) To solve the spin polarization problem discussed above. 2) To enable effective training techniques. 3) To minimize the adjustment of the backbone hardware. A pure quadratic term is used to replace the linear term in the Ising Hamiltonian:

$$\begin{matrix}{ℋ}_{R V} = - {\sum }_{i \neq j}^{N} {J}_{i j} {σ}_{i} {σ}_{j} + {\sum }_{i}^{N} {h}_{i} {σ}_{i}^{2} , & {σ}_{i} ∈ ℝ\end{matrix} \qquad Equation 5$$

It can be inferred that J and h still represent spin coupling and self-reaction similar to the Ising model, inheriting the connectivity, expressivity, and the information propagation ability from it. Additionally, this Hamiltonian can be formulated more compactly as

$${ℋ}_{R V} = - {\sum }_{i \neq j}^{N} {J}_{i j} {σ}_{i} {σ}_{j}$$

with Jᵢᵢ=−hᵢ, indicating that (−h) is embedded in J′ as the diagonal line. If h is positive, the convexity of the Hamiltonian is ensured, enabling the existence of local minima. As will be discussed shortly, h is guaranteed positive with the training method, and the adjustment in Hamiltonian can be easily implemented on top of the backbone hardware.

THE TRAINING METHOD OF NP-GL HAMILTONIAN. The training for Hamiltonian parameters aims to map the energy ground state to the maximum likelihood with real-valued data. It consists of two major components: the conditional likelihood method as the backbone, and two optimization methods to enhance training quality.

THE CONDITIONAL LIKELIHOOD METHOD AS BACKBONE. To perform real-valued training with affordable computing power, a conditional likelihood method is disclosed. The spin configuration of the model is denoted as S={σ₁, . . . , σ_{N}}. The joint probability density function of spin configuration S is defined under the Boltzmann distribution:

$$p ( S \vert J , h ) = {Z}^{- 1} exp \{ - {ℋ}_{R V} \} \qquad Equation 6$$

where Z is the partition function. Instead of maximizing the likelihood for the observed samples altogether which is computationally infeasible, a conditional likelihood is maximized as an approximation. That is to say, the parameters are optimized by focusing on one spin (say, σᵢ) at a time, while treating other spin values as conditions. In particular, [symbol] is split into [symbol] and [symbol] to represent the terms dependent and independent of σᵢ. The joint probability density then becomes:

$$p ( {σ}_{i} , {σ}_{∖ i} ) = {Z}^{- 1} exp \{ - {ℋ}_{R V , i} - {ℋ}_{R V , ∖ i} \} \qquad Equation 7$$

If one considers all σ_{\i} as conditions, [symbol] becomes a constant. Subsequently,

$$p ( {σ}_{i} = μ \vert {σ}_{∖ i} ) ∝ exp \{ - {ℋ}_{R V , i} {\vert}_{{σ}_{i} = μ} \} \qquad Equation 8$$

Specifically,

$${ℋ}_{R V , i} {\vert}_{{σ}_{i} = μ} = - {ε}_{i} μ + {h}_{i} {μ}^{2} \qquad Equation 9$$

where μ is the spin variable, and

$${ε}_{i} = - {\sum }_{j \neq i}^{N} {J}_{ij} {σ}_{j}$$

for conciseness. It is apparent that [symbol] is minimized at μ=ε/2 hᵢ, which is determined by the trained parameters and the other conditional spin values. This indicates that the value of a spin can converge between its upper and lower bounds, fundamentally supporting real-valued data. To train this model, either the Mean Square Error (MSE) loss or the L1 loss between μ=εᵢ/2hᵢ and the ground truth is utilized to maximize the conditional likelihood. Once the training is complete, the maximum conditional likelihood is obtained, which is automatically mapped to the energy ground state according to Equation 8.

This training approach is applicable to both spatial and spatial-temporal models. In the former scenario, the spins only represent the nodes at the same time step, while in the latter case, more spins are necessary to represent the nodes from past, current, and future time steps.

TRAINING ENHANCEMENT TECHNOLOGIES. With the training backbone established, there are still two questions remain to be answered. 1) J and h have distinct physical meanings. Is there a way to differentiate them during training? 2) How can the similarity between spatial and temporal correlations be leveraged?

Diagonal Line Reinforcement (DLR): J and h are trained jointly with the training method described above. However, these two types of parameters have distinct physical meanings: coupling and self-reaction. In practice, they also usually differ by orders of magnitude. To differentiate these parameters in training, h is reinforced on the diagonal line of J by multiplying a scaling factor as a hyperparameter. This method is applicable to both spatial and spatial-temporal models. As FIG. 1A illustrates, the diagonal line of Jₛₚₐₜᵢₐₗ is directly multiplied by the factor to reinforce the self-reaction. Similarly, in a spatial-temporal model, all four submatrices have their individual diagonal lines reinforced, enhancing both the self-reaction and the temporal coupling of the same node.

Spatial Pre-training Coupled with Temporal Fine-tuning: Intuitively, Spin A at time t and t+1 may have similar properties. For instance, they may have similar coupling relations with respect to Spin B, as FIG. 1C shows. Based on this, the temporal couplings may be speculated to have similar values as the spatial couplings. To exploit this property, a spatial model featured as J_{N×N} is pre-trained and mapped onto a spatial-temporal model as initial values. The model is subsequently finetuned to obtain a final model. Through this approach, the similarity between spatial and temporal correlations is leveraged, resulting in improved accuracy and convergence speed. FIG. 1C is a diagram showing the fine-tuning of a pre-trained spatial model. J_{AB}: the coupling between Spin A and B.

INFERENCE WITH A NEW NATURE-BASED COMPUTER. The Aiming to harness the power of nature and achieve an end-to-end solution for graph learning, the inference process is carried out on a nature-based computer modified from a SOTA Ising machine to align with the upgrade in the Hamiltonian. The overall layout of the computer is shown in FIG. 1D, in which the nodes are connected through the coupling units in an all-to-all manner.

TABLE 1
Accuracy comparison (in MAE / RMSE): the lower
the better - best results are in bold.

| | Application | | | |
|---|---|---|---|---|
| | Traffic Flow | | Air Quality | |
| Dataset | PEMS04 | PEMS08 | PM2.5 | PM10 |
| Graph WaveNet | 20.84 / 33.66 | 15.77 / 24.03 | 1.823 / 3.106 | 1.954 / 3.496 |
| ASTGCN | 20.79 / 33.39 | 15.68 / 23.73 | 1.883 / 3.133 | 2.255 / 3.662 |
| MTGNN | 19.96 / 31.64 | 15.15 / 22.79 | 1.833 / 2.933 | 1.990 / 3.303 |
| DDGCRN | 18.97 / 30.59 | 14.64 / 22.42 | 1.711 / 3.004 | 1.881 / 3.315 |
| MegaCRN | 17.65 / 29.25 | 13.70 / 21.03 | 1.646 / 2.863 | 1.741 / 3.098 |
| NP-GL-Vanilla-MSE | 18.37 / 29.10 | 16.02 / 24.31 | 1.710 / 2.868 | 1.860 / 3.146 |
| NP-GL-MSE | 18.09 / 28.66 | 15.11 / 23.40 | 1.702 / 2.859 | 1.862 / 3.144 |
| NP-GL-L1 | 17.07 / 27.66 | 13.51 / 21.69 | 1.624 / 2.914 | 1.730 / 3.013 |

| | Application | |
|---|---|---|
| | | Pandemic |
| | | Progression |
| | Taxi Demand | Texas |
| Dataset | NYC TAXI | COVID |
| Graph WaveNet | 10.22 / 21.24 | 82.96 / 430.1 |
| ASTGCN | N/A*** | N/A |
| MTGNN | 7.079 / 15.40 | 84.17 / 414.2 |
| DDGCRN | 3.059 / 10.21 | 23.94 / 188.8 |
| MegaCRN | 6.082 / 15.01 | 83.73 / 423.6 |
| NP-GL-Vanilla-MSE | 3.741 / 11.41 | 41.46 / 268.9 |
| NP-GL-MSE | 3.195 / 9.610 | 37.60 / 268.8 |
| NP-GL-L1 | 3.031 / 10.08 | 22.04 / 117.7 |

***Graph topology is unavailable for NYC Taxi and Texas COVID datasets. Different from MTGNN and Graph WaveNet, ASTGCN does not support graph topology generation.

Specifically, the spin values are represented as the voltage on the capacitors in the nodes, while the parameters J′ and h are represented as conductance. On the right-hand side of the figure, the modifications show that that merely replacing the voltage regulator “ZIV” with a variable resistor in each node imports the quadratic term

$${\sum }_{i} {h}_{i} {V}_{i}^{2}$$

into Hamiltonian. The electric current of Node i is written as equation 10, where Jᵢⱼ′ is the effective conductance of the coupling between nodes and 2hᵢ is the effective conductance of the added variable resistor in the node.

$$\frac{{dV}_{i}}{dt} = \frac{1}{C} ( {I}_{in} - {I}_{vr} ) = \frac{1}{C} ( {\sum }_{j \neq i} {J}_{ij}^{′} {V}_{j} - 2 {h}_{i} {V}_{i} ) = - \frac{1}{C} \frac{\partial {ℋ}_{RV}}{\partial {V}_{i}} \qquad Equation 10$$

which satisfies:

$$\frac{\partial {ℋ}_{RV}}{dt} = {\sum }_{i} ( \frac{\partial {ℋ}_{RV}}{\partial {V}_{i}} \frac{{dV}_{i}}{dt} ) = - C {\sum }_{i} {( \frac{{dV}_{i}}{dt} )}^{2} \leq 0 \qquad Equation 11$$

This suggests the Hamiltonian described by the CMOS compatible circuit spontaneously decreases. In other words, the lowest energy state is automatically pursued.

After the Hamiltonian parameters J and h are obtained from training, they are deployed on the nature-based computer for inference. In practice, the spins representing the nodes from the previous and current time steps are fixed to the known data, allowing the spins representing the nodes in future to evolve and reach the spin configuration with the lowest energy, thus performing the prediction. FIG. 1D is a diagram showing the nature-based computer upgraded from its binary predecessor to support real values.

EXPERIMENTAL RESULTS: EXPERIMENTAL SETUP. Applications and Datasets. The NP-GL framework with four real-world spatial-temporal applications and six real-world datasets including Traffic Flow, Air Quality, Taxi Demand, and Pandemic Progression as follows is evaluated. Application: Traffic Flow-Prediction of the number of vehicles passing through detectors per unit time; Datasets: PEMS04 & PEM08—Traffic flow data in metropolitan areas of California. Application: Air Quality-Prediction of air pollution levels; Datasets: CAQRA-PM2.5 & CAQRAPM10-Chinese historical PM2.5 and PM10 data from 2019.5 to 2019.12 sampled from the Chinese Air Quality Reanalysis (CAQRA) database. Application: Taxi Demand—Prediction of the hourly number of taxi trips; Dataset: NYC Taxi—The hourly number of taxi trips in New York City in 2022. Application: Pandemic Progression-Prediction of the daily number of new cases; Dataset: Texas COVID-2020-2023 daily case increment of COVID-19 in Texas.

Baselines. For fair evaluation, NP-GL accuracy and inference latency is compared with five SOTA spatial-temporal GNNs including Graph WaveNet (Wu et al., 2019b), ASTGCN (Guo et al., 2019), MTGNN (Wu et al., 2020), DDGCRN Weng et al. (2023), and MegaCRN Jiang et al. (2023). Platforms. NVDIA A100-40 GB GPUs and AMD Ryzen Threadripper PRO 3975WX CPUs are used to measure the inference latency of the baseline GNNs. The nature-based computer utilized to evaluate the performance of NP-GL is adapted from the current SOTA Ising machine, BRIM (Afoakwa et al., 2021), based on Cadence Analog Design Environment.

EVALUATION OF ACCURACY. Table 1 compares the accuracy of predicting the t′th snapshot based on the (t−1)'th snapshot with five GNN baselines and two NP-GL variants. NP-GL-Vanilla-MSE is equipped with the DLR optimization. NP-GL-MSE is further improved with Spatial Pre-training and Temporal Fine-tuning. NP-GL-L1 uses L1 loss instead of MSE loss compared with NP-GL-MAE, as the data outliers may significantly affect the accuracy. Mean Absolute Error (MAE) and Root Mean Squared Error (RMSE) that reflect the average and the deviation of the result quality are adopted as the accuracy metrics for comparison. For the MAE metric, NP-GL outperforms all 5 baselines across all datasets. For RMSE, except for PEMS08 where MegaCRN is slightly better, NP-GL outperforms all other baselines.

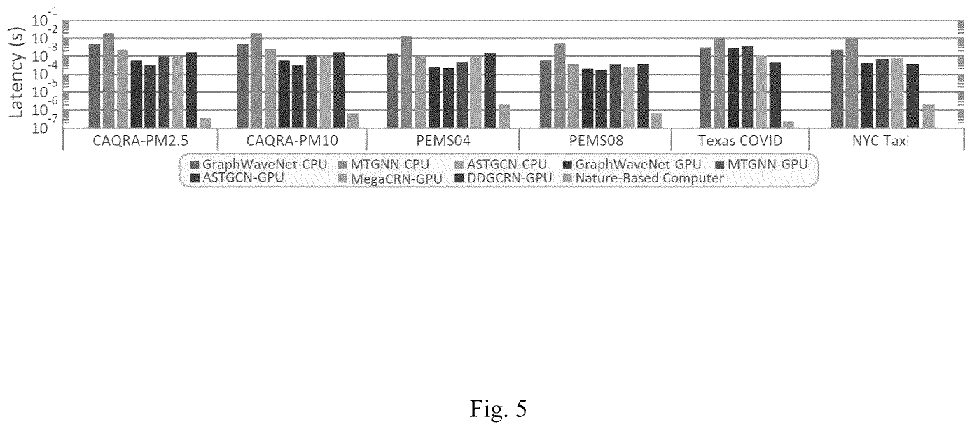

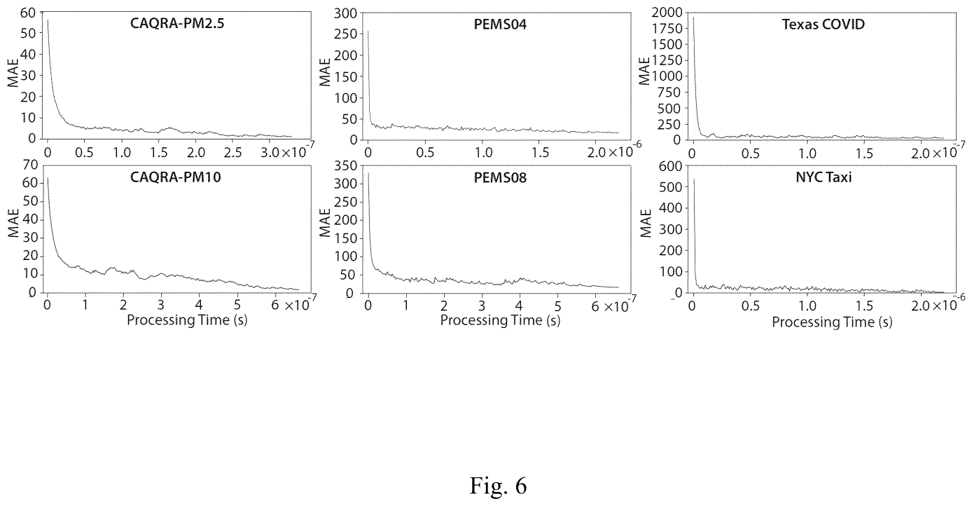

EVALUATION OF LATENCY. This section evaluates the inference latency of NP-GL. FIG. 5 compares the inference latency of GNNs and NP-GL, highlighting the extraordinarily short latency introduced by the nature-based computer that is powered by nature and operates at extremely high speed. In the figure, the nature-based computer delivers orders of magnitude speedup (from 10³ to 10⁴) compared to CPU and GPU results across all datasets and baselines. Specifically, 1.70×10⁴ speedup is achieved on average for the Texas COVID dataset, while the dataset with the least speedup (NYC Taxi) still impressively reaches 1.01×10³. To highlight a comprehensive result, the mean value of all 6 average speedups is taken to obtain the overall average speedup as 6.97×10³. FIG. 6 shows spin evolution processes of the nature-based computer throughout inference. As the spins evolve towards the lowest energy state, the error of the results found by the computer decreases accordingly. The curves show the nature-based computer rapidly optimizes the spin configurations to approach the lowest energy states which are also the desired learning solutions. In terms of energy consumption, the nature-based computer operates at a power of ~500 mW, more than 100× lower than modern GPUs and CPUs. The overall energy consumption is approximately 10⁵ less than GPUs and CPUs.

FIG. 5 is a diagram showing the latency comparison of CPU, GPU, and NP-GL nature-based computer. FIG. 6 is a diagram showing the natural process of energy decrease in NP-GL computer to find desired inference results.

This example extends the computational power of nature to real-world graph learning problems by proposing NP-GL. Specifically, NP-GL is a nature-powered graph learning model and solves real-valued graph learning problems by harnessing the natural phenomenon of energy decrease. Experimental results across 4 real-world applications with 6 datasets demonstrate that NP-GL delivers, on average, 6.97×10³ speedup and 10⁵ energy consumption reduction with comparable or even higher accuracy than GNNs.

DATASETS. NP-GL is evaluated with four real-world spatial-temporal applications and six real-world datasets listed below. Their specification details is reported in Table 2. All datasets are partitioned into 70/20/10 percentages for training, validation, and test purposes.

TABLE 2
Dataset specifications. A snapshot is the state
of the data at a specific point in time.

| | Application | | | |
|---|---|---|---|---|
| | Traffic Flow | | Air Quality | |
| Dataset | PEMS04 | PEMS08 | CAQRA-PM2.5 | CAQRA-PM10 |
| # of Snapshots | 16992 | 17856 | 5856 | 5856 |
| # of Nodes | 307 | 170 | 400 | 400 |
| Data Range | 919 | 1147 | 167.0 | 186.9 |
| (Max-Min) | | | | |

| | Application | |
|---|---|---|
| | Taxi | |
| | Demand | Pandemic |
| | NYC | Progression |
| Dataset | Taxi | Texas COVID |
| # of Snapshots | 8759 | 1100 |
| # of Nodes | 259 | 256 |
| Data Range | 1115 | 25190 |
| (Max-Min) | | |

HYPERPARAMETERS. For all experiments carried out on the six datasets (detailed specifications reported in Table 2), the Rprop optimizer is adopted with a custom early-stop mechanism. The same hyperparameters are used across the experiments except for the DLR factors used to reinforce diagonal lines of J, which are listed in Table 3.

TABLE 3
DLR Factors as the Hyperparameters for Different Datasets.

| | Application | | | | | |
|---|---|---|---|---|---|---|
| | | | | | Taxi | Pandemic |
| | Traffic Flow | | Air Quality | | Demand | Progression |
| | Dataset | | | | | |
| | PEMS04 | PEMS08 | PM2.5 | PM10 | NYC Taxi | Texas COVID |
| DLR Factor | 12.28 | 8.50 | 16.00 | 6.00 | 12.95 | 5.89 |

TABLE 4
The universal hyperparameters used for all 6 datasets.

| Minibatch | LR | Etas | Step Sizes | LR Decay | Step Decay | Early Stop |
|---|---|---|---|---|---|---|
| 64 | 0.01 | (0.5, 1.2) | (1E−4, 50) | 0.5 | 50 | 1E−6 |

The rest of the hyperparameters are listed in Table 4, where LR is the initial learning rate, Etas and Step Sizes are the hyperparameters intrinsic to the Rprop optimizer. To implement an early stop mechanism, the learning rate is multiplied by 0.5 (LR Decay) if the loss function does not decrease in 50 epochs (Step Decay). Once the learning rate is below 1E-6 (Early Stop), the training process is terminated.

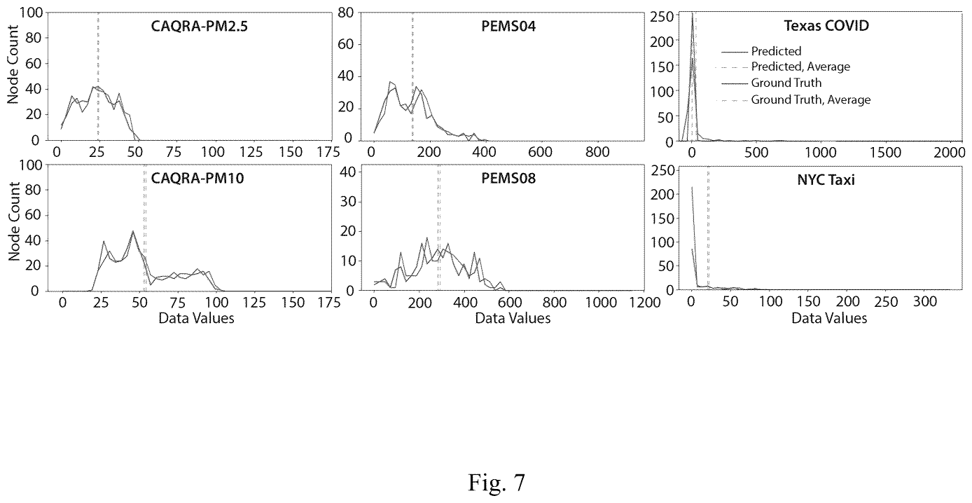

DATA DISTRIBUTION PROFILING. The example predicted data distribution and the ground truth distribution across all 6 datasets are illustrated in FIG. 7. The examples are randomly sampled from the snapshots used for graph prediction. It can be observed that despite the datasets have distinct data ranges and distributions, the predicted data distribution obtained is very close to the ground truth, with the mean data values (dashed lines) almost identical. FIG. 7 is a diagram showing the data distribution comparison of the predicted data and ground truth data.

### Example 2: DS-GL: Advancing Graph Learning Via Harnessing Nature's Power within Scalable Dynamical Systems

This example discloses a nature-powered graph learning framework dubbed Dynamical System Graph Learning (DS-GL), which is the first effort to transform the process of solving graph learning problems into the natural annealing process within a parameterized dynamical system embodied as a CMOS chip. To tackle the two major hurdles, DS-GL first augments the Ising machine architecture to modify the self-reaction term of its Hamiltonian function from linear to quadratic, effectively serving as an energy regulator. This adjustment maintains the system's original physical interpretation while enabling it to process continuous, real-valued data. Second, to address the scaling issue, DS-GL further upgrades the real-valued dense Ising machine by decomposing it into a mesh-based multi-PE dynamical system that supports efficient distributed spatial-temporal co-annealing across different PEs through sparse interconnects. By exploiting the inherent sparsity and community structures in real-world graphs, DS-GL is able to map complex graph learning tasks onto the scalable dynamical system while maintaining high accuracy. Evaluations with four diverse GL applications across seven real-world datasets, including traffic flow and COVID-19 prediction, show that DS-GL can deliver from 10³× to 10⁵× speedups over Graph Neural Networks on GPUs while operating at a power 2 orders of magnitude lower than GPUs, with 5%-30% accuracy enhancement. Index Terms-Dynamical System, Graph Learning, Nature-Powered Computing

As the world experiences rapid informatization and digitalization, a growing number of applications are turning to non-Euclidean data with high complexity and best represented as graphs. These applications span a broad spectrum of critical areas, including power grid cascading failure prediction, traffic flow management, and pandemic forecasting, among many others. Most of these applications pose stringent demands on real-time processing, low energy consumption, and simultaneously high accuracy. Meeting these demands presents substantial challenges, primarily due to the intrinsic complexity and irregularity of graph data [T. Geng et al., 2020].

Graph Neural Networks (GNNs), as the current State-Of-The-Art (SOTA) Graph Learning (GL) approach, have recently drawn tremendous attention due to their strong capability to extract latent information from graph data. Following years of advancements in algorithms [J. Baek et al., 2020], [W.-L. Chiang et al., 2019], [F. Frasca et al., 2022] and the development of specialized hardware accelerators [T. Geng et al., 2020], [R. Sarkar et al., 2023], [B. Zhang et al., 2023], [Y. Zhang et al., 2021], GNN research is transitioning into an era of practical application. The pursuit of exceptional accuracy has spurred the emergence of numerous application-specific GNNs [W. Weng et al., 2023], [Z. Wu et al., 2020], characterized by their rapidly escalating algorithmic complexity and the consequent need for tremendous computational power. Historically, the fast growth in computational power of digital hardware, driven by Moore's Law, has facilitated the pursuit of enhanced accuracy through trading model complexity while maintaining computational efficiency. Regrettably, the approaching end of Moore's Law has cast a shadow over the future advancement and real-world adoption of GNNs. While the optimization of digital processors remains a vital area of exploration, it is equally imperative to investigate alternative computational paradigms and assess their potential in advancing the field of GL.

The recent development of CMOS-compatible Ising machines [R. Afoakwa et al., 2021], coupled with their impressive efficacy in addressing traditional graph problems (e.g., max-cut), suggests that the intrinsic power of nature within dynamical systems can be potentially exploited in GL. Specifically, an Ising machine is a parameterized dynamical system of CMOS components governed by the Hamiltonian of the Ising model. Ising model: a binary statistical physical model widely used to represent dynamic systems; Hamiltonian: the energy function of dynamic systems. This machine, akin to other dynamic systems in reality, is propelled by its intrinsic nature to autonomously chase and find the most stable states with the lowest energy—a phenomenon termed as natural annealing. Unlike other dynamic systems where annealing might be slow, such as ink diffusion in water, the Ising machine rapidly evolves to these low-energy states at “the speed of electrons” through the natural movement of electrons seeking equilibrium. When the parameters of the Ising machine are properly configured, ensuring that the desired outcomes of a problem correspond to the lowest energy states, the machine can solve these problems through natural annealing with extraordinarily low latency and energy consumption. Taking graph cut as an example, a ~200 mW Ising machine can perform high-quality max-cut delivering orders of magnitude speedup over 200 W GPUs.

The remarkable capabilities of modern Ising machines present a compelling question: Can the natural computational power of such dynamical systems be leveraged to advance graph learning by simultaneously offering clearly lower latency, better energy efficiency, and higher accuracy? Most graph learning problems fundamentally target dynamical systems, e.g., power grid, traffic systems, and supply chain. It is natural to wonder whether a programmable dynamical system can better analyze the behaviors of these dynamical systems than general-purpose processors. Intuitively, the answer is affirmative. Specifically, a dynamical system whose data distribution aligns with that of the target Graph Learning (GL) problem was constructed by training the system's parameters with the problem's training data. Accurate alignment ensured that the system's lowest energy states corresponded to the desired GL solutions with the highest probability. Consequently, the dynamical system can swiftly conduct GL inference through natural annealing at negligible cost. The statistical basis underpinning this method is analogous to that of modern generative AIs, such as stable diffusion [J. Karras et al., 2023].

Unfortunately, in practice, the full potential of Ising machines in real-world GL cannot be realized until two major challenges are addressed. 1) Binary Nature: Ising machines focus only on binary values (Ising spins), limiting their applications in real-valued contexts. Efforts [G. E. Hinton, 2012] to circumvent this limitation by using multiple binary nodes to represent high-precision values not only compromise solution quality but also necessitate a substantial increase in the required number of nodes of the machine, exacerbating the second problem-scalability. 2) Poor Scalability: To enhance versatility and solution quality, SOTA Ising machines use all-to-all connections with n² couplers connecting n nodes through a huge crossbar, ensuring direct and immediate interactions between any two nodes during annealing. However, this design leads to scalability issues. Attempts [T. Takemoto et al., 2019], [M Yamaoka et al., 2015] to improve scalability using partially connected interconnects with uniform patterns, such as King's graph topology (where each physical node connects with eight neighbors), fall short in handling high-degree nodes, a common occurrence in real-world graphs. In light of this, a new Dynamical-System-based Processing Unit (DSPU)—capable of supporting real-valued natural annealing and scalable for GL applications—is disclosed herein.

To this end, this example discloses a novel Dynamical-System-based Graph Learning framework, DS-GL, which incorporates a real-valued and scalable DSPU coupled with a series of training algorithms for constructing efficient and scalable dynamical systems for GL problems. FIG. 2A is a diagram showing the overview of DS-GL framework and its performance over GNNs. The overview of DS-GL is illustrated in FIG. 2A. Specifically, to enable stable real-valued natural annealing, DS-GL first upgrades the SOTA Ising machine hardware with a circulative resistor ring and the self-reaction term of its corresponding Hamiltonian; then, a training algorithm that accurately configures the system is developed. The algorithm transforms the process of solving GL problems into a process of natural annealing. Coupled with this algorithm, the new “Real-Valued DSPU” can perform real-valued GL with high performance and accuracy. To enhance the scalability, DS-GL further upgrades Real-Valued DSPU into a larger system, dubbed “Scalable DSPU”, with a mesh-based multi-PE architecture that efficiently supports distributed spatial-temporal co-annealing; coupled with a learning-based clustering algorithm that can reconstruct dense dynamical systems into the sparse ones with community structures while maintaining high accuracy in natural annealing, Scalable DSPU can solve over 4× larger real-valued GL problems than an Ising machine with only a 30% increase in chip area.

DS-GL is the first work that uses physical dynamical systems and harnesses their intrinsic nature's computational power to solve real-world graph learning problems and outperforms SOTA GNN solutions. The contributions are summarized below: A novel nature-powered graph learning framework, DS-GL, that unleashes the inherent computational power of dynamical systems in graph learning is disclosed; learning-based algorithms that accurately transform the process of solving graph learning problems to the natural annealing process of sparse dynamical systems with a hardware-friendly community structure is disclosed; A new dynamic-system-based processing unit, Scalable DSPU, rooted in a CMOS-compatible Ising machine is disclosed. Scalable DSPU inherits the extraordinary computational efficiency of the Ising machine and extends its potential to real-valued and larger-scale GL problems. Experimental results across four real-world applications and seven datasets show that DS-GL achieves from 10³× to 10⁵× speedup and 5%-30% higher accuracy over GNNs on GPUs while operating at a power 2 orders of magnitude lower than GPUs.

Ising Model The Ising model [S. G. Brush, 1967] is a statistical model widely used in the study of physics, chemistry, and biology. The Ising model is defined by its energy function or Hamiltonian:

$${ℋ}_{Ising} = - {\sum }_{i \neq j}^{N} {J}_{ij} {σ}_{i} {σ}_{j} - {\sum }_{i}^{N} {h}_{i} {σ}_{i} \qquad Equation 12$$

where σᵢ∈{−1, +1} represents the spins within the system. Jᵢⱼ is the coupling parameter representing the correlation between spin i and spin j, and hᵢ refers to the self-reaction strength to external influences.

BRIM: the Current SOTA Ising Machine. Ising machines are essentially physical embodiments of the Ising model. Specifically, through their designed spin dynamics, lower energy states of the Ising Hamiltonian are automatically pursued. Besides many existing Ising machines implemented with quantum or optical components, CMOS-based Ising machines have recently emerged and drawn increasing attention due to their low-barrier deployment. One typical example is BRIM [R. Afoakwa et al., 2021]. Furthermore, they typically solve problems through the movement of electrons among electronic components such as capacitors, therefore being able to deliver solutions with the “speed of electrons”. Despite the many advantages and potential of Ising machines, their unique problem-solving power has only been demonstrated for binary problems. Inspired by the superior performance of BRIM in solving graph optimization problems, DS-GL was developed, which takes the BRIM architecture reported in [R. Afoakwa et al., 2021] as a building block. Before delving into DS-GL design, the BRIM architecture below is first briefly introduced.

FIG. 2B shows the overview of the BRIM architecture. The values of nodes are represented by the voltages of capacitors in each Nᵢ block. To facilitate all-to-all connection among nodes, BRIM is equipped with a fully-connected coupling network (the network of Jᵢⱼ blocks) based on programmable resistors. Therefore, the differences between the voltages of nodes will naturally generate currents among the coupling network to reduce the system energy and push the system towards equilibrium. Programming Units are used to program BRIM by configuring the coupling parameters of the network (i.e., the resistance of the programmable resistors). The couplers are programmed column by column controlled by the Column Select Unit. Node Control Unit is in charge of node value initialization and flipping the binary values of nodes at runtime for effective annealing. More details can be found in [R. Afoakwa et al., 2021].

Graph Learning. In the context, GL refers to the acquisition of unknown graph node features using observed node features. Taking GNNs for example, node features are obtained by iteratively aggregating features from neighboring nodes. During GL training, the spatial and temporal relations among graph nodes are distilled into a selected model (GNNs or DS-GL), which processes observed node features as its input and generates unknown node features as its output. The model's parameters are adjusted (through backward-propagation in GNNs) according to the discrepancies between the generated outputs and the ground truth. This refinement process allows the model parameters to effectively capture the underlying distribution of the data. During inference, the trained model consumes the observed node features and generates the corresponding unknown node features. Particularly, for temporal prediction tasks, GL uses historical graph information to predict the future states of the graph.

REAL-VALUED GL ON DENSE DYNAMICAL SYSTEMS. Despite the exceptional capability of CMOS-compatible Ising machines in solving binary optimization problems like max-cut, the binary limitation hinders the method's further deployment for real-world graph learning problems. However, lifting the binary restriction is not a trivial task, as the adjustment made to this model must be general enough to accommodate real-world problems, and practical enough for hardware implementation.

To enable real-value support, modifications applied to the model are introduced, together with Real-Valued DSPU, which incorporates the hardware upgrade to the baseline BRIM to establish the basic hardware components for this work.

The Binary Limitation and Hardware Upgrade. A naive approach to facilitate real-value support is to directly extend the variables σ from binary to real-value. However, σ do not converge to real values but are polarized towards ±∞. This polarization can be justified by a stationary point analysis on the Hamiltonian. The stationary points are reached by solving for the following condition:

$$\frac{\partial ℋ}{\partial σ} = - ( J σ + h ) = 0 ; diag ( J ) = 0 \qquad Equation 13$$

Spins and parameters are shown in their matrix form, with linear substitutions (Jᵢⱼ+Jⱼᵢ)→Jᵢⱼ, and 2hᵢ→hᵢ. Next, the Hessian matrix H is applied to analyze the properties of stationary points.

$$H ( {ℋ}_{Ising} ) = - J = constant ; diag ( J ) = 0 \qquad Equation 14$$

As J is a constant matrix, all stationary points share the same property. If all the eigenvalues of H(H)|σ₀ are positive, the stationary points σ₀ are local minima; if all negative, local maxima; otherwise, σ₀ are saddle points. Notice that diag(J)=0, based on the linear algebraic property

$$tr ( J ) = {\sum }_{i}^{N} λ i ,$$

where λᵢ is the i'^{th} eigenvalue of J, there is a mixture of positive and negative eigenvalues, thus saddle points. In practice, the saddle points are not stable as they have zero tolerance for fluctuation, leading to diverging spins. Essentially, this divergence is due to diag(J)=0. To compensate, pure quadratic or higher-order terms of σ are necessary.

This can also be viewed in an intuitive way. According to the Ising Hamiltonian (Equation 12), the lowest energy state approaches −∞. Even if an upper bound and a lower bound are applied to prevent σ from reaching infinity, the resulting variables are polarized at their upper or lower bound, essentially reducing a real-valued problem to binary.

Algorithm-wise, as a countermeasure to the polarized σ, the original Ising model is modified as Equation 15 demonstrates:

$${H}_{RV} = - {\sum }_{i \neq j}^{N} {J}_{ij} {σ}_{i} {σ}_{j} - {\sum }_{i}^{N} {h}_{i} {σ}_{i}^{2} \qquad Equation 15$$

In the modified model, only the second term is different—a pure quadratic term to replace the original linear term is now used. In this way, the second term still represents the self-reaction of a spin, preserving the physical interpretation. Meanwhile, the pure quadratic term prevents the variables from diverging given the negative and sufficiently large parameters h, as this modified term contributes to a quadratic increase in energy.

With the model generalized to support real values, the hardware needs enhancements satisfying the following criteria: 1) variables (voltages) must be able to stabilize as real values. 2) the spontaneous decrease in Hamiltonian must be satisfied.

The first criterion is satisfied through the implementation of circulative resistor rings, as depicted in FIG. 2C. This setup incorporates the variable resistor Ry within a node along with the pairwise coupling mechanism between nodes to achieve the desired functionality. To accommodate both positive and negative values of J, each pair of nodes is equipped with two circulative resistor rings. FIG. 2C is a diagram showing the real-Valued DSPU architecture. Left: the circulative resistor ring. Right: the detailed node internals for real-value support.

In baseline BRIM, without the resistor regulating the voltage, σ continues to vary whenever there is an incoming current until the capacitor is fully charged, only to represent polarized values. Now with the presence of the resistor, nonzero currents are enabled to flow consistently through this node, allowing σ to be stabilized at

$$σ = {I}_{vr} {R}_{V} = {I}_{in} {R}_{V} = - {\sum }_{j \neq i} \frac{{J}_{ij} {σ}_{j}}{{h}_{i}} \qquad Equation 16$$

Similar to J, the parameters h also have the unit of Ω⁻¹, corresponding to the conductance of resistors embedded in the nodes on hardware. Meanwhile, real-world graph nodes are modeled as variables σ, physically implemented as the voltages applied to the nano-scale capacitors.

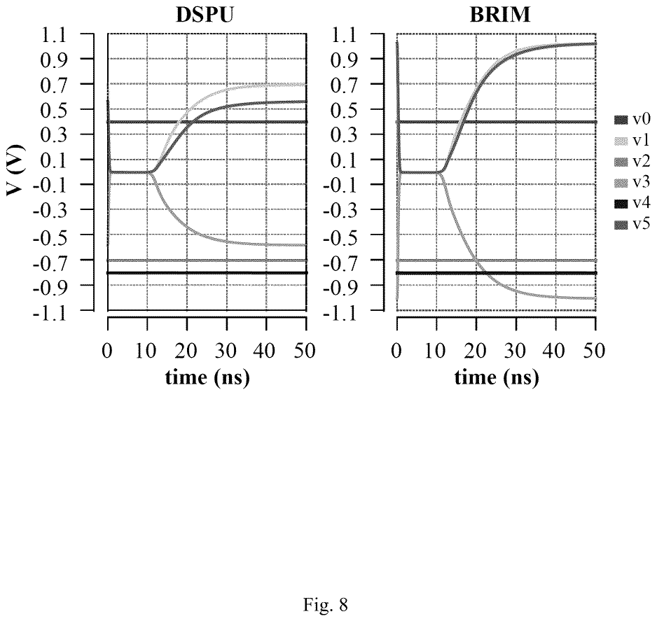

The stabilization capability is further demonstrated by circuit-level validation. For clarity, an illustrative graph consisting of 6 spins, labeled v0~v5 in FIG. 8, which are separately deployed on DSPU and BRIM platforms is considered. In this setup, v0, v2, and v4 are predetermined as inputs, leaving the others free to evolve. With identical input and coupling parameters, the DSPU yields real-valued outcomes between the upper and lower bounds, whereas BRIM only produces two polarized values. FIG. 8 is a set of plots showing the circuit-level validation.

To meet the second criterion, the dynamics of the variables is designed through Lyapunov analysis, establishing a dynamical system of electrons that can be deployed on hardware. Accordingly, the following inequality needs to be satisfied:

$$\frac{{dH}_{RV}}{dt} = {\sum }_{i} \frac{\partial {H}_{RV}}{\partial {σ}_{i}} \frac{d {σ}_{i}}{dt} \leq 0 \qquad Equation 17$$

Obviously, the variable dynamics can be designed as:

$$\frac{d {σ}_{i}}{dt} = - \frac{1}{C} \frac{\partial {H}_{RV}}{\partial {σ}_{i}} \qquad Equation 18$$

where C is a positive constant with the unit of capacitance. Substituting this equation into Eq. (17), the quadratic (∂H_{RV}/∂σᵢ)² appears, satisfying the target inequality above. The following question is, how to map it on hardware? In fact, the equation is automatically satisfied with the resistors. Based on textbook capacitor knowledge, this equation:

$$\frac{d {σ}_{i}}{dt} = \frac{1}{C} ( {I}_{in} - {I}_{vr} ) = - \frac{1}{C} {\sum }_{j \neq i} {J}_{ij} {σ}_{j} - {h}_{i} {σ}_{i} \qquad Equation 19$$

agrees with the shape of ∂H_{RV}/∂σᵢ and effectively facilitates the spontaneous energy decrease.

Model Training. To provide a complete view of the disclosed work and show how the dynamical system is tamed, the training algorithm here is briefly introduced. The training process aims to obtain a set of parameters J and h that map the desired real-valued result to the lowest energy state, in other words, to construct a data distribution described by a dynamical system. During training, to guarantee the convexity of the Hamiltonian, the parameters h are forced to be negative. Subsequently, the lowest energy state can be obtained by letting the first derivative of the Hamiltonian equal to zero:

$$\frac{\partial {ℋ}_{RV}}{\partial {σ}_{i}} = - {\sum }_{i \neq j}^{N} ( {J}_{ij} + {J}_{ji} ) {σ}_{j} - 2 {h}_{i} {σ}_{i} = 0 \qquad Equation 20$$

Without losing generality, (Jᵢⱼ+Jⱼᵢ)→Jᵢⱼ is substituted, and 2hᵢ−hᵢ. The regression formula for σ is then derived:

$${σ}_{i} = \frac{- {\sum }_{i \neq j}^{N} {J}_{ij} {σ}_{j}}{{h}_{i}} \qquad Equation 21$$

which is exactly the hardware stability criterion (Equation 16). That is, given the current parameters J/h, and the values of all other variables as conditions, the difference between the computed variable σᵢ and its ground truth is used as a loss function, updating the parameters through back-propagation.

Inference on a Dynamical System. With the learned parameters, GL inference can be interpreted as the evolution of the dynamical system. The observed graph nodes are considered as input, while the remaining unknown nodes are taken as output. To initiate the inference process, the input observed nodes are fixed to the observations, as the capacitors are charged and maintained accordingly.

Meanwhile, the unknown nodes are randomly initialized. Next, the natural annealing process starts and the system approaches equilibrium, so as to locate a lowest energy state.

SCALABLE GL ON SPARSE DYNAMICAL SYSTEMS. This section tackles the scalability hurdle by co-designing the learning-based algorithm for decomposing dense dynamical systems and the multi-PE dynamical system architecture.

Overview of Scalable DS-GL. Despite the communication effectiveness of all-to-all interactions among nodes, the size of the coupling network increases quadratically with the number of nodes. To address the problem of scalability, the design strategy is to prune links based on the strength of inter-node connections, which refers to the magnitude of coupling parameters. Compared to the weakly coupled nodes, strongly coupled nodes are observed to contribute predominantly to the quality of solution. Considering the fact that real-world graphs are typically extremely sparse with communities composed of strongly-related nodes, it is feasible to only preserve strong connections and relax the weak links between the communities. To accomplish this, as FIG. 2D illustrates, DS-GL is trained as a dynamical system with community structure through three steps: i) prune the fully connected coupling matrix to a sparse matrix depending on the coupling strength; ii) extract the communities indicated within the sparse matrix, and group the communities into “super-communities” to match per-DSPU capacity; iii) further reform the coupling matrix to fit the desired sparse interconnection pattern. To alleviate communication pressure, different super-communities are interconnected through a sparse hierarchy, including Chain, Mesh, DMesh (Diagonally-connected Mesh [W.-H. Hu et al.,) 2018]), and Wormholes (for unavoidable global communication outliers). FIG. 2D is a diagram showing the workflow of Scalable DS-GL. Blocks labeled 111: algorithm for coupling matrix decomposition. Blocks labeled 112: the architecture of Scalable DSPU.

On the hardware side, to provide the foundation for scaling, a mesh-based network “Scalable DSPU” is designed as a grid of small DSPUs comprised of Processing Elements (PEs) and Coupling Units (CUs). In essence, each PE serves as a local dynamical system, with neighboring PEs linked through a limited number of analog I/Os via CUs for instantaneous synchronization. In the 2D mesh, communities of nodes are mapped to different DSPUs with their interconnections sparsified into patterns. The patterns are specially designed for efficient “co-annealing” processes upgraded from the annealing concept in Real-Valued DSPU. Furthermore, the co-annealing process is categorized into Spatial co-annealing and Temporal & Spatial co-annealing for different scenarios. Consequently, the scalability of Scalable DSPU is optimized with balanced annealing quality and efficiency.

Training Algorithm for Decomposing Dynamical System. For the disclosed dynamical system, the scalability issue arising from the all-to-all connection can be decomposed into three sub-problems. First, to reduce communication complexity, how to decompose the dynamical system to sparsify the coupling matrix? Second, assuming the coupling is sparse, how to perform computing efficiently? Third, accuracy will drop during the sparsification, how to restore the accuracy? To answer these questions, the solution is also three-fold.
1) Decomposition of the dynamical system. Communities typically exist in real-world graphs as a valuable property. Similar to cliques in graph theory, communities consist of nodes with dense interconnects but with sparse connections to the external nodes. It can be inferred that although more information is embedded in the original all-to-all node interconnection, the majority of the interconnects should be redundant and removable with minimal consequences.

The key is to extract the communities in the target graphs, which is a well-researched topic. In this work, the Louvain algorithm [V. D. Blondel et al., 2008] is adopted due to its high efficiency and scalability. To start, the number of non-zero elements (defined as “communication demand density” and annotated as “D” in this work) is limited in the coupling matrix in order to attain an initial sparse coupling matrix for communities extraction. In the next steps, after communities are extracted, they are further sparsified by eliminating weak couplings, drastically reducing the demand for communication bandwidth.
2) Community redistribution. The extracted communities are grouped into super-communities, with each initially distributed to a PE. However, the size of a single community occasionally exceeds the pre-defined hardware capacity of a PE, causing the demand for the community to be further decomposed into smaller sub-communities to fit on hardware. As a consequence, this redistribution process potentially reduces connections within communities, causing accuracy to drop. To make amends, the sub-communities are redistributed onto neighboring super-communities for more communication opportunities. In the meantime, larger communities are granted higher priority to be redistributed. In FIG. 2E (left), for example, assuming that the largest community (or a sub-community of the largest community when it exceeds hardware capacity) fits into super-community 0, it is centered to have more connections with its neighbors. The second largest community is then distributed to super-community 0 if allowed by capacity, otherwise to super-community 1. Finally, for the sake of a balanced workload, smaller communities or isolated nodes are redistributed to fill the blanks left by larger communities on super-communities. Through these redistribution approaches, the locality of communities is exploited with the utilization of a single super-community enhanced. FIG. 2E is a diagram showing the four types of communication patterns.
3) Parameter fine-tune with patterns. With the communities extracted and redistributed, the final problem is addressed—to restore the lost accuracy in these processes. To this end, a fine-tuning process is conducted with constraints to develop a communication-friendly pattern.

To maintain the general coupling matrix pattern obtained from the previous steps, a controlling mask is generated to confine the regions in the coupling matrix where non-zero elements can populate during the fine-tuning process, also eliminating non-zeros outside the region due to the pre-set communication demand density D.

Next, the interconnect pattern of the super-communities is studied. In FIG. 2E (left), four patterns are summarized, which respectively correspond to four types of connections between the super-communities on a 2-D array. FIG. 2E (right) shows the distribution of the patterns in the re-ordered coupling matrix. The links labeled 121 represent the “Chain” type of connections between neighbor super-communities such as 0 and 1. The “Mesh” type of patterns contains all the connections between neighbor super-communities on the 2-D array as links labeled 123 including the one between 0 and 3, as well as all of the “Chain” type of patterns. The links labeled 125 show the additional connections in “DMesh” type of patterns based on “Mesh” which refer to the diagonal connections between super-communities such as 0 and 2. The “Wormhole” in FIG. 2E refers to super-connections over the 2-D array, supporting rare connections between any two super-communities, for example, 7 and 13.

Disclosed Hardware Architecture. The structurally sparse coupling matrix with clustered non-zeros obtained through the decomposition of the dynamical system brings opportunities to achieve efficient and accurate natural annealing with highly sparse dynamical systems.

To this end, a Scalable DSPU is disclosed, a new dynamical system architecture based on Real-Valued DSPU disclosed herein. FIG. 2F shows the disclosed hardware architecture. Scalable DSPU is equipped with a 2D array of Processing Elements (PEs). Each PE is a small Real-Valued DSPU with additional buffers, routers, and digital controllers for the support of co-annealing. The PEs are connected to a mesh-based network through configurable Coupling Units (CUs) at the intersection of the mesh. Each CU contains a mini coupling crossbar, which can be reconfigured as different types of connections to bridge nodes from the neighbor PEs. During natural annealing, each PE is in charge of the local annealing of a single super-community. Mesh-based interconnect network, together with the configurable CUs, builds direct connections for nodes that are from different PEs but with non-zero coupling parameters. During annealing, voltage differences across node pairs drive currents across different PEs, enabling “Spatial co-annealing”. When the number of nodes in a PE that need to communicate with external nodes exceeds the limited input/output capacity of this PE, these nodes will occupy the I/O in a time division multiplexing manner, which is scheduled collaboratively by their PE and the corresponding CUs, enabling the Temporal & Spatial co-annealing. In the following, the architecture design of each major super-community in Scalable DSPU is elaborated on in detail. FIG. 2F is a diagram showing the hardware architecture of Scalable DSPU.

PE architecture: As shown in FIG. 2F, each PE contains K nodes (blocks connected to Routers labeled 230, 232 respectively). All nodes are fully connected through an internal KxK crossbar coupling network, like in Real-Valued DSPU. Different from Real-Valued DSPU, the nodes are divided into two partitions. Each partition contains k/2 nodes and is connected to either Bottom-Left (BL) & Top-Right (TR) routers or Top-Left (TL) & Bottom-Right (BR) routers. Each router, jointly controlled by Spatial and Temporal Schedulers, is able to route its own share of nodes to its corresponding two neighboring CUs through analog-based exporting portals at the four corners of the PEs. The Spatial Scheduler selects the nodes that need to be connected with external PEs and supervises the corresponding Router to allocate I/O resources at one of the selected exporting portals for the nodes. This builds the foundation of Spatial co-annealing. The Temporal Scheduler is in charge of selecting nodes for temporal co-annealing when the number of nodes that need to communicate with external PEs exceeds the I/O resources (L lanes within each portal) at the exporting portals. Each PE is also equipped with several banks of buffers that cache the communication mapping information generated during training.

CU architecture: CU is at the intersection of the mesh-based network and is used to connect PEs to the network. The coupling parameters in a CU are stored locally in the In-CU Weight Buffer controlled by the Weight Select module. Similarly to PEs, each CU has four exporting portals which connect the CU with four PEs. To align the communication bandwidths of CUs and PEs, each portal in a CU is also equipped with L lanes of connection. Therefore, each CU can be connected with 4L nodes in four neighboring PEs simultaneously. Each CU is equipped with a 4L×3L crossbar connecting all pairs of nodes in different PEs. Note that a CU does not need a 4L×4L full-size crossbar as the nodes from the same PE are already fully connected locally. With nodes from different PEs directly connected within CUs, their Spatial co-annealing is enabled. Here, the number of lanes in each portal of both CU and PE (L) is defined as hardware communication capability. In the evaluation, L is set as 30 for better performance and hardware tradeoff.

Interconnect Architecture: The interconnect architecture of Scalable DS-GL is composed of two parts: 1) the connections between exporting portals of CUs and PEs together compose a tiled mesh-based interconnect (the grid of links labeled 121 in FIG. 2F); and 2) the super connections (lines labeled 126 in FIG. 2F) that connect exporting portals of neighboring CUs compose another grid-based interconnect (the links labeled 129 in FIG. 2F). As aforementioned, the grid of lines labeled 123 enable the Spatial co-annealing among nodes from neighboring PEs. In contrast, the yellow grid enables the co-annealing among nodes from remote PEs. From the perspective of the coupling matrix, the scattered non-zeros located in the blank space require remote communication in pursuit of efficient and accurate annealing and therefore require “Wormholes”. To open a Wormhole for two nodes from remote PEs, the corresponding PEs first map both nodes to their neighboring CUs and then enable the super connections in the route between the two CUs.

Analog I/O Details: FIG. 2G shows the signal channel between two nodes from different PEs containing two high-speed analog switches and an analog resistive component, i.e., CU coupling unit. In each PE, a router selects the corresponding analog switches to establish analog connections between nodes in the PEs and ports on the CU, thereby enabling the inter-PE communication via the analog coupling crossbar in CUs. This analog-fashioned connection avoids extra A/D or D/A conversion and fully supports heterogeneous interconnect patterns in FIG. 2E, leveraging the flexibility of analog coupling crossbars in CUs and routers in PEs. As shown in FIG. 2F, each node in a PE can be connected to up to 4 neighbor CUs. Within each CU, a node is further connected to up to 90 nodes from 3 neighboring PEs through the coupling network. FIG. 2G is a diagram showing the detailed PE-to-CU connections via Analog I/O.

Challenge in decomposing large-scale graphs: With DSGL, graphs can be decomposed more aggressively without sacrificing accuracy than GNNs. The underlying reasons are two-fold. First, as an electronic dynamical system, DS-GL hardware constantly propagates node information to their directly connected neighbors through the movement of electrons (flow of electric current) among capacitors, facilitating fast and long-range cascading information propagation among remotely connected nodes. Therefore, with DS-GL, information can be seamlessly transmitted even among nodes that are not directly connected. This feature is distinguished from GNNs, where information is propagated from one node to its neighbors for only once per layer. Second, for nodes in the clusters that are not directly connected through CUs, if their connections are critical for high accuracy, the Wormhole interconnection introduced above will be enabled to establish direct connections among them. It is worth highlighting that the “Wormholes” require no extra hardware, but only share little resources from CUs to enable direct connections among remote PEs with considerable bandwidth.

Featuring Co-Annealing Methods. Since the disclosed sparse dynamical system is no longer fully connected, the natural annealing process in a Real-Valued DSPU should be adjusted accordingly. In particular, two imperative problems are confronted. First, in contrast to the all-to-all connections in a Real-Valued DSPU, what modifications are required in the hardware to make the PEs collaboratively anneal through the sparse connections? Second, how can the hardware manage situations where its capacity is inadequate to facilitate the concurrent annealing of all nodes? In response to these problems, the co-annealing approaches are also categorized in a bipartite manner. (a) Spatial co-annealing is the standard annealing process performed on the disclosed sparse dynamical system. Given the communication patterns of the super-communities, natural annealing is collectively performed in all super-communities leveraging the disclosed hierarchical interconnect architecture. (b) Temporal & Spatial co-annealing is designed in the case of insufficient capacity of the dynamical system. In this scenario, one Spatial co-annealing is transformed into iterative partial annealing until convergence is reached.

Spatial co-annealing method: FIG. 2H depicts the coupling between two example PEs on the left, demonstrating the sparse communication pattern between nodes. The squares labeled 250 denote the communication facilitated between the nodes depicted as the squares labeled 252, aka “activated nodes”. Subsequently, annealing is performed following the communication pattern as Spatial co-annealing, featuring its real-time synchronization capability through CUs. In the framed box centered in FIG. 2H, taking PE1 for example, the Spatial co-annealing mechanism starts from a “PE-CU Map Buffer” which stores all the lists of activated nodes to be deployed to neighbor CUs. For a hardware configuration with specific L, the mapping method is further selected depending on whether D is less than L. If yes, the Spatial co-annealing method shown in the box 270 with dotted frame is applied. In this situation, the spatial scheduler directly fetches the node-to-CU mapping information from “PE-CU Map Buffer”. It first detects the overlapping between the nodes to different CUs, and then generates the mapping signal to the routers. Meanwhile, the “Super Connect” module sends a control signal to enable communication between CUs for overlapped nodes or “Wormhole” patterns. Since the communication demand density is lower than the hardware communication capability, all nodes can be directly mapped to the corresponding CUs. The TR CU of PE1 is drawn in the figure as an example, where the weights (or the coupling parameters) for the couplings in the CU are stored locally in the “In-CU Weight Buffer” in each CU. For Spatial co-annealing, the weights do not change and are programmed to the coupling crossbar via DACs. FIG. 2H is a diagram showing the hardware architecture for Spatial co-annealing and Spatial & Temporal co-annealing methods.

Temporal & Spatial co-annealing method: In the high communication demand density scenario, when D is greater than L, the CUs become saturated with some unaddressed couplings, and the standard Spatial co-annealing no longer applies. Under this circumstance, a Temporal & Spatial co-annealing approach is adopted, with a single Spatial co-annealing decomposed into iterations of partial annealing. In FIG. 2H, the box labeled 280 with dotted frame shows the hardware for the Temporal co-annealing component, which functions collectively with the Spatial co-annealing part as follows. First, the node lists from the “PE-CU Map Buffer” are sent to the temporal scheduler to divide the lists into smaller “slices”, with each size not greater than L. The slices are then stored in the “Temporal Map Buffer”, where the buffer sends only one group of slices at a time to the spatial scheduler for further spatial mapping. The “Switch Controller” generates the control signals to inform the buffer to exchange the groups of slices in turn, namely, a Switch-in-turn process. Since the weight parameters in a CU need to be exchanged within different slices, the switch control signals are also connected to the “Weight Select” module in the CU. In this way, high communication demand is supported by the disclosed hardware architecture, even with limited capacity of CUs.

EVALUATION: In this section, the tradeoff between communication density and accuracy, and that between inference latency and accuracy are evaluated. In addition, DS-GL is compared with various SOTA GNNs across different hardware platforms on the following metrics: accuracy, latency, energy, and hardware costs.

Experimental Setup: Applications and Datasets. The disclosed framework on seven real-world datasets from four application scenarios is evaluated. 1) Traffic flow prediction: traffic [R. Jiang et al., 2023] contains the traffic flow data in Japan. 2) Air quality prediction: PM25, PM10, NO2 and O3, containing PM2.5, PM10, NO2, and O3 data from 2019.5 to 2019.12 in Chinese Air Quality Reanalysis database [L. Kong et al., 2021]. 3) Pandemic progression prediction: Covid [7] contains 2020-2023 daily case increments of COVID-19 in US. 4) Stock price prediction: predicting the daily prices of stocks. Stock [O. Onyshchak, 2020] contains prices for tickers trading on NASDAQ up to 2020.4.

Algorithm Baselines. For fair evaluation, three SOTA spatial-temporal GNNs are selected as the baselines, including GWN [Z. Wu et al., 2019], MTGNN [Z. Wu et al., 2020], and DDGCRN [W. Weng et al., 2023]. Their hyperparameters are set according to their released codes.

Platforms. NVIDIA A100 40 GB SXM GPUs are used to measure the training time, inference latency, and accuracy of the SOTA GNNs. For DS-GL, the accuracy and latency are measured using a CUDA-based Finite Element Analysis (FEA) software simulator implemented on top of the one of BRIM [R. Afoakwa et al., 2021]. Cadence Mix-signal Design Environment (with 45-nm technology node) is used to evaluate the power and area of DSPU and DS-GL.

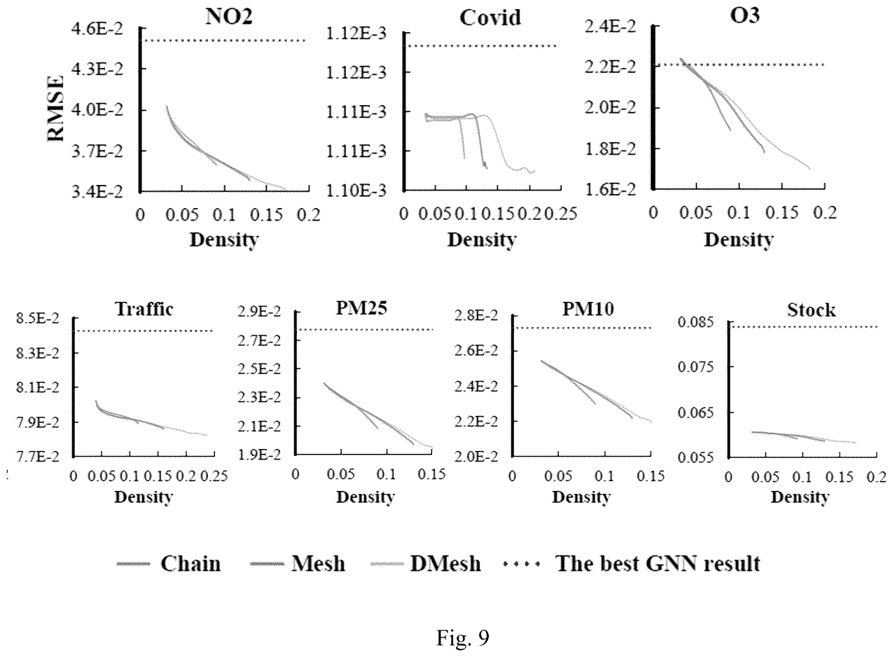

Tradeoff among Accuracy, Latency, and Graph Sparsity. FIG. 9 shows the accuracy (in Root Mean Square Error, RMSE) of DS-GL with different levels of post-decomposition graph sparsity (=1−Density) and various decomposition patterns across seven real-world graph learning problems. The decomposition patterns include Chain, Mesh, and DMesh, each with Wormhole enabled. The red dotted lines represent the best accuracy of the selected SOTA GNNs. Results show that the accuracy of DS-GL increases with higher graph density (or lower graph sparsity). Moreover, more complex communication patterns enable higher flexibility in graph decomposition, therefore resulting in higher accuracy. FIG. 9 is a series of plots showing the DS-GL accuracy (RMSE) vs the density of coupling matrix (proportion of nonzero elements; sparsity=1-density) with different communication patterns. “Chain/Mesh/DMesh” refer to different communication patterns with Wormhole enabled.

TABLE 5
HARDWARE COMPARISON WITH BRIM,
A SOTA ISING MACHINE

| | Effective | | | | |
|---|---|---|---|---|---|
| | spins | Power | Area | Scalable | Data type |
| BRIM [R. | 2000 | 250 mW | 5 mm² | No | Binary |
| Afoakwa et | | | | | |
| al., 2021] | | | | | |
| DSPU-2000 | 2000 | 260 mW | 5.1 mm² | No | Real-Value |
| DS-GL | 8000 | 550 mW | 6.5 mm² | Yes | Real-Value |

TABLE 6
RMSE COMPARISON BETWEEN DS-GL AND SOTA GNNS.

| Dataset | NO2 | Covid | O3 | Traffic | PM25 | PM10 | Stock |
|---|---|---|---|---|---|---|---|
| GWN [Z. | 5.52e−2 | 1.75e−3 | 2.40e−2 | 1.27e−1 | 3.20e−2 | 2.74e−2 | 8.44e−2 |
| WU ET AL., | | | | | | | |
| 2019] | | | | | | | |
| MTGNN [Z. | 4.51e−2 | 1.85e−3 | 2.23e−2 | 1.14e−1 | 2.83e−2 | 2.73e−2 | 8.39e−2 |
| WU ET AL., | | | | | | | |
| 2020] | | | | | | | |
| DDGCRN | 5.17e−2 | 1.16e−3 | 2.21e−2 | 8.43e−2 | 2.77e−2 | 2.78e−2 | 8.42e−2 |
| [W. WENG | | | | | | | |
| ET AL., | | | | | | | |
| 2023] | | | | | | | |
| DS-GL- | 3.94e−2 | 1.11e−3 | 2.21e−2 | 7.97e−2 | 2.37e−2 | 2.53e−2 | 6.06e−2 |
| SPATIAL | | | | | | | |
| DS-GL- | 3.60e−2 | 1.11e−3 | 1.89e−2 | 7.89e−2 | 2.08e−2 | 2.30e−2 | 5.92e−2 |
| CHAIN | | | | | | | |
| DS-GL- | 3.48e−2 | 1.11e−3 | 1.78e−2 | 7.86e−2 | 1.97e−2 | 2.22e−2 | 5.86e−2 |
| MESH | | | | | | | |
| DS-GL- | 3.41e−2 | 1.11e−3 | 1.70e−2 | 7.83e−2 | 1.93e−2 | 2.19e−2 | 5.82e−2 |
| DMESH | | | | | | | |

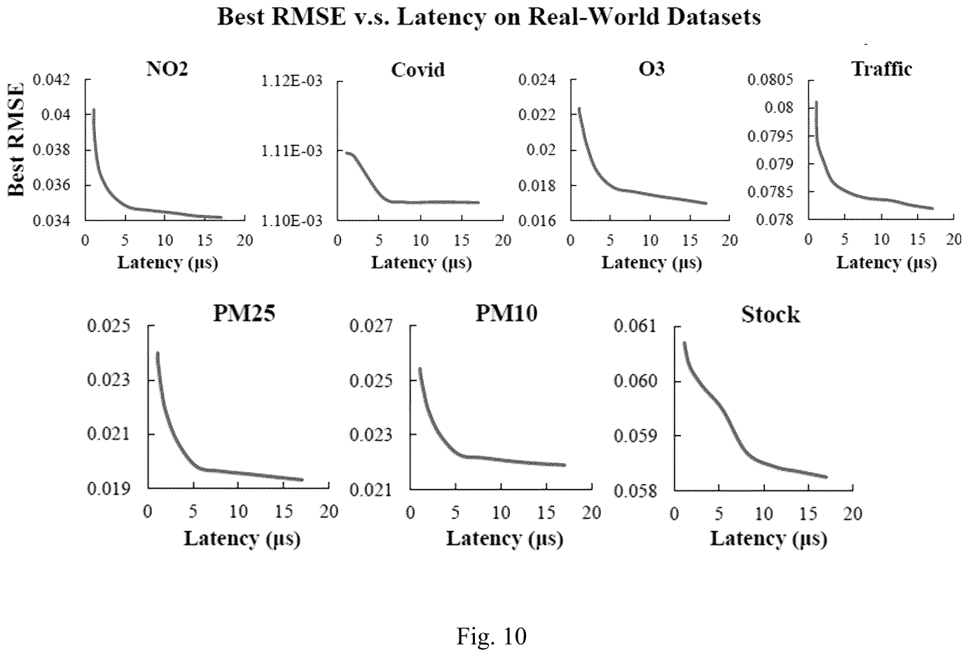

FIG. 10 shows the best accuracy obtainable with different inference latency. Recall that while a high density of the coupling matrix enhances accuracy, it often exceeds hardware capacity. Therefore, Temporal & Spatial co-annealing is adopted to support higher density at the cost of increased annealing time (i.e., inference latency), leading to a tradeoff between accuracy and latency. For most datasets, the RMSE decreases sharply with increasing latency until an inflection point (~5 μs), after which the decline is more gradual. FIG. 10 is a series of plots showing the DS-GL Accuracy vs inference latency (annealing time). Temporal & Spatial co-annealing is adopted for higher accuracy with longer annealing time.

Evaluation of DS-GL Hardware Costs The hardware costs of BRIM, DSPU, and DS-GL are listed in Table 5, where DSPU-2000 refers to a DSPU consisting of 2000 spins for a fair comparison with BRIM [R. Afoakwa et al., 2021]. It shows that the Real-Valued DSPU can support real-world problems with minor extra costs compared to the binary machine. Furthermore, DS-GL scales the number of spins by 4× at the cost of 2× higher power.

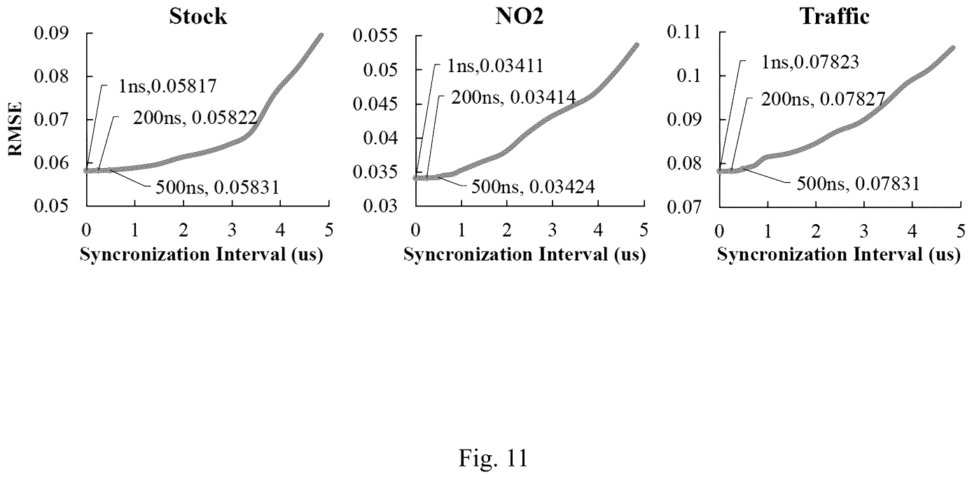

Evaluation of Inter-tile Synchronization. Although DS-GL does not need synchronization among tiles within the same mapping, synchronization is necessary among multiple mappings. Specifically, the synchronization frequency ( 1/500 ns) required for high accuracy is much lower than that supported by the DS-GL hardware ( 1/200 ns). To demonstrate the efficacy of synchronization, FIG. 11 uses Stock, NO2, and Traffic datasets to evaluate the variation in accuracy (RMSE) over the synchronization interval from 1 ns to 5 μs. FIG. 11 shows that the accuracy generally decreases with the increase of synchronization interval. However, the accuracy drop is negligible when synchronization interval is less than 500 ns, which is easily achievable on the DS-GL hardware. FIG. 11 is a series of plots showing the RMSE vs Synchronization Interval, with 200 ns used in DS-GL.

Accuracy Comparison with SOTA GNN. Table 6 compares the accuracy among four DS-GL design choices and three SOTA GNNs including GWN [Z. Wu et al., 2019], MTGNN [Z. Wu et al., 2020], and DDGCRN [W. Weng et al., 2023]. The accuracy is evaluated in terms of RMSE. The four design choices include “DS-GLSpatial”, “DS-GL-Chain”, “DS-GL-Mesh”, “DS-GL-DMesh”. Particularly, DS-GL-Spatial refers to the design with only spatial co-annealing (temporal co-annealing disabled) which trades accuracy for low inference latency. In contrast, “DSGL-Chain”, “DS-GL-Mesh”, and “DS-GL-DMesh” represent the designs with different decomposition patterns, each with both spatial and temporal co-annealing enabled, therefore, delivering slower inference but higher accuracy. As the table shows, DS-GL outperforms SOTA GNNs on all datasets. Taking the air-quality-NO2 dataset as an example, DS-GLSpatial achieves 12.6%-28.6% reduced RMSE compared to SOTA GNNs while DS-GL-DMesh achieves 22.4%-38.2% RMSE reduction.

Latency & Energy Comparison with Accelerators & GPU. In Table. 6, DS-GL exhibits substantial accuracy improvements over SOTA GNNs. To further evaluate the latency and energy efficiency, a comparison with several SOTA hardware accelerators is presented, including AWB-GCN [T. Geng et al., 2020], I-GCN [T. Geng et al., 2021], NTGAT [W. Hou et al., 2023], GraphAGILE [B. Zhang et al., 2023], and RACE [H. Yu et al., 2023]. Since GNN models are often specifically designed for these applications, while accelerators are not designed for these models—for a fair comparison, these accelerators are assumed to be of full utilization, achieving peak TFLOPs with typical power. Even with this assumption, DS-GL still consistently outperforms all SOTA accelerators and modern GPU on both latency and energy consumption, as summarized in Table 7.

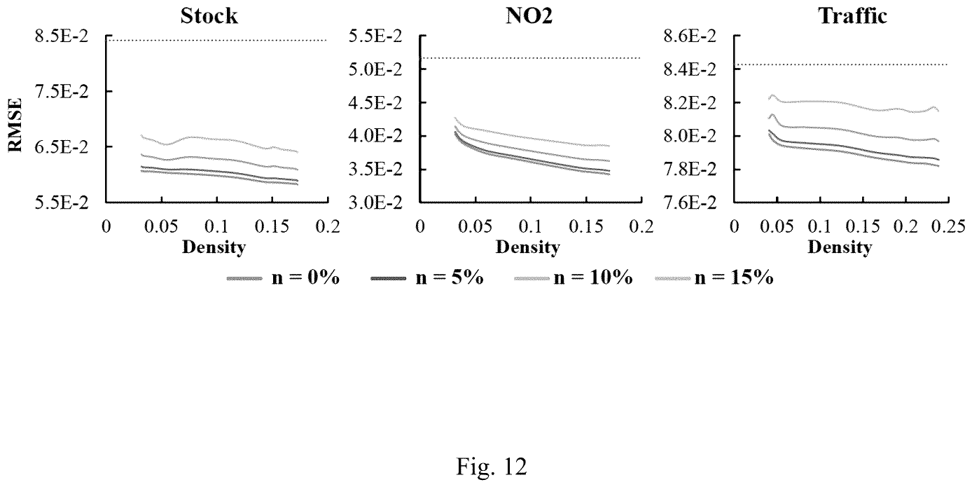

Evaluation of System robustness. To estimate the impact of noise on the system, dynamic noises is injected at both nodes and coupling units. The noise is generated by the Gaussian distribution with standard deviation values of 5%, 10%, and 15% each. The results of three representative datasets with ‘DMesh’ pattern are shown in FIG. 12, where n in the legend represents the standard deviation of noise. The impact of dynamic noise is not significant, showing the natural good tolerance of physical dynamical systems to noise. As a result, in practical situations, DS-GL still achieves better accuracy over the GNNs. FIG. 12 is a series of plots showing the RMSE vs matrix density under noise percentage n.

TABLE 7A
COMPARISON OF INFERENCE LATENCY AND ENERGY COST PER INFERENCE
AMONG DS-GL, SOTA GNNS ON GNN ACCELERATORS, AND GPUS PART 1.

| Hardware Platforms | Stratix 10 SX | Xilinx Alveo U200 |
|---|---|---|
| Related Works† | AWB [T. Geng et al., 2020], IGCN | NTGAT [W. Hou et al., 2023] |
| | [T. Geng et al., 2021] | |
| Peak TFLOPS | 2.7 | 1.4 |
| Max Power (W) | 215 | 225 |
| Typical Power (W) | 137 | 100 |

| Application | | covid | air | traffic | stock | covid | air | traffic | stock |
|---|---|---|---|---|---|---|---|---|---|
| GNNs | GWN | 1141 | 1335 | 985 | 1751 | 2203 | 2578 | 1902 | 3382 |
| Latency | MTGNN | 516 | 604 | 446 | 792 | 996 | 1166 | 860 | 1530 |
| (μs) | DDGCRN | 690 | 847 | 443 | 1063 | 1333 | 1636 | 855 | 2051 |
| DS-GL Latency (μs) | | 0.15 | 1.1 | 0.65 | 1 | 0.15 | 1.1 | 0.65 | 1 |
| GNNs | GWN | 156 | 183 | 135 | 240 | 220 | 258 | 190 | 338 |
| Energy | MTGNN | 70.7 | 82.7 | 61 | 109 | 100 | 118 | 85.1 | 152 |
| (mJ) | DDGCRN | 94.6 | 116 | 60.6 | 145 | 134 | 165 | 85.4 | 205 |
| DS-GL | Energy | 9.00E−05 | 6.00E−04 | 4.00E−04 | 6.00E−04 | 9.00E−05 | 6.00E−04 | 4.00E−04 | 6.00E−04 |
| | (mJ) | | | | | | | | |

TABLE 7B
COMPARISON OF INFERENCE LATENCY AND ENERGY COST PER INFERENCE
AMONG DS-GL, SOTA GNNS ON GNN ACCELERATORS, AND GPUS PART 2

| Hardware Platforms | Xilinx Alveo U250 | Xilinx Alveo U280 |
|---|---|---|
| Related Works† | GraphAGILE [B. Zhang et al., 2023] | RACE [H. Wu et al., 2023] |
| Peak TFLOPS | 2.8 | 2.1 |
| Max Power (W) | 225 | 225 |
| Typical Power (W) | 110 | 100 |

| Application | | covid | air | traffic | stock | covid | air | traffic | stock |
|---|---|---|---|---|---|---|---|---|---|
| GNNs | GWN | 1101 | 1289 | 951 | 1691 | 1469 | 1719 | 1268 | 2255 |
| Latency | MTGNN | 498 | 583 | 430 | 765 | 664 | 777 | 574 | 1021 |
| (μs) | DDGCRN | 667 | 818 | 427 | 1018 | 889 | 1090 | 570 | 1364 |
| DS-GL Latency (μs) | | 0.15 | 1.1 | 0.65 | 1 | 0.15 | 1.1 | 0.65 | 1 |
| GNNs | GWN | 121 | 142 | 105 | 186 | 147 | 172 | 127 | 225 |
| Energy | MTGNN | 54.9 | 64.1 | 46.9 | 84.2 | 66.5 | 78 | 57.5 | 101 |
| (mJ) | DDGCRN | 73.2 | 89.9 | 47.1 | 113 | 89.1 | 110 | 56.8 | 136 |
| DS-GL | Energy | 9.00E−05 | 6.00E−04 | 4.00E−04 | 6.00E−04 | 9.00E−05 | 6.00E−04 | 4.00E−04 | 6.00E−04 |
| | (mJ) | | | | | | | | |

TABLE 7C
COMPARISON OF INFERENCE LATENCY AND ENERGY
COST PER INFERENCE AMONG DS-GL, SOTA GNNS
ON GNN ACCELERATORS, AND GPUS PART 3.

| Hardware Platforms | NVIDIA A100 SXM |
|---|---|
| Related Works^{†} | |
| Peak TFLOPS | 156 |
| Max Power (W) | 400 |
| Typical Power (W) | 250 |

| Application | | covid | air | traffic | stock |
|---|---|---|---|---|---|
| GNNs | GWN | 2757 | 4601 | 4176 | 5333 |
| Latency (μs) | MTGNN | 9319 | 1.60E+04 | 1.20E+04 | 2.30E+04 |
| | DDGCRN | 3.70E+04 | 6.00E+04 | 2.60E+04 | 1.20E+05 |
| DS-GL Latency (μs) | | 0.15 | 1.1 | 0.65 | 1 |
| GNNs | GWN | 674 | 1138 | 984 | 1298 |
| Energy (mJ) | MTGNN | 2241 | 4164 | 2973 | 5419 |
| | DDGCRN | 9457 | 1.50E+04 | 6392 | 3.00E+04 |

| | | | | |
|---|---|---|---|---|
| DS-GL Energy (mJ) | 9.00E−05 | 6.00E−04 | 4.00E−04 | 6.00E−04 |

^{†}The latency of GNN accelerators is reported based on their theoretical peak performance with full utilization.

Multi-Dimensional Applications. To further demonstrate the wide applicability of DS-GL, two datasets (house prices in California [P. Mooney, 2021] and global climate [N. Elgiriyewithana, 2023], denoted separately as CA housing and climate) including multiple features for a node are evaluated, with results shown in Table 8. For example, climate contains 12 features per node, including humidity, temperature, wind speed, etc. Latency is evaluated on an A100-40G SXM GPU.

TABLE 8
RMSE & LATENCY COMPARISON ON
MULTI-DIMENSIONAL DATASETS.

| | Multi-Dimensional Dataset | | | |
|---|---|---|---|---|
| | CA housing | | climate | |
| | | latency | | latency |
| Comparison Metric | RMSE | (μs) | RMSE | (μs) |
| GWN [Z. Wu et al., 2019] | 1.89e−2 | 6.40e+3 | 4.32e−1 | 1.37e+4 |
| MTGNN [Z. Wu et al., 2020] | 2.10e−2 | 2.08e+4 | 4.33e−1 | 1.87e+4 |
| DDGCRN [W. Weng et al., 2023] | 1.86e−2 | 5.03e+4 | 4.03e−1 | 3.54e+4 |
| DS-GL | 1.62e−2 | 1.08 | 3.89e−1 | 0.97 |

RELATED WORKS. Variances of Ising Machines: In addition to BRIM, there are many other Ising machine concepts and prototypes including D-Wave's quantum annealers that have been put into commercial use [The D-Wave 2000Q quantum computer]. As a quantum Ising machine, a D-Wave annealer [R. Harris et al., 2010] takes advantage of the quantum effects introduced by its superconducting qubits to achieve extraordinary speed. However, quantum Ising machines require a cryogenic system for extremely low temperatures as the operating environment. This cryogenic system is also the main reason for its high energy consumption (~25 KW), which significantly limits its practical use at the current stage. In Coherent Ising machines (CIM) [T. Inagaki et al., 2016], [P. L. McMahon et al., 2016], [Y. Yamamoto et al., 2017], optical parametric oscillators are used to represent spins, while the coupling is currently emulated through digital computation. Consequently, the efficiency of current CIMs is rather limited. In contrast, Ising machines based on electric oscillators are closer to real-life deployment, but may require hard-to-integrate inductors for high-quality oscillations. However, a 48-oscillator Ising machine [H. Lo et al., 2023] using ring oscillators has recently emerged, demonstrating the potential in this approach.

Among the choices of Ising machines, BRIM is uniquely fitted to the purpose in this work in contrast to two other groups of Ising machines designs: 1) Oscillator-based Ising machines use oscillator phase (φᵢ) as the spin [I. Ahmed et al., 2020], [J. Chou et al., 2019], [T. Honjo et al., 2021], [T. Inagaki et al., 2016], [W. Moy et al., 2022], [T. Wang and J. Roychowdhury, 2019]. These spins are not Ising spins (1 degree of freedom: ±1) but XY model spins (2 degrees of freedom) with the following Lyapunov function: H=−Σ_{i,j}Jᵢⱼ·cos(φᵢ−φⱼ). Hence they do not lend to real-value quadratic objective function as naturally as BRIM does. 2) Digital annealers/accelerators are hardwired annealing algorithms [S. Xie et al., 2022], [M. Yamaoka et al., 2015]. They are certainly more efficient than general-purpose processors, but do not yet rival SOTA dynamical systems in efficiency. Besides, almost all such designs in the literature acquire extra efficiency by using local coupling and/or single-bit coupling, making them impractical for real-world problems.

Existing works on Ising Machines for ML: The potential of Ising machines in solving ML problems has only been recently recognized. Recent works have attempted to use BRIM to solve or partially solve simple learning problems including predicting traffic congestion [Z. Pan et al., 2023], collaborative filtering [Z. Liu et al., 2023], and supporting energy-based models [U. Vengalam et al., 2023]. However, those works only support binary problems (e.g., “congested (0)” or “non-congested (1)”) in congestion prediction and “like” or “dislike” in binary collaborative filtering). Moreover, the congestion prediction work [Z. Pan et al., 2023] uses BRIM to impute invisible congestion data within the same timestamp, while the temporal prediction is performed on digital processors. In [Z. Liu et al., 2023], BRIM is used to determine whether a user will “like” or “dislike” an item determined by the similarity between items. Like congestion prediction, no temporal evaluation is performed by the Ising machine in [Z. Liu et al., 2023]. Furthermore, both works offer solutions tailored to specific applications, whereas DS-GL accommodates a broader range of real-valued applications that necessitate intricate analysis of temporal information.

This example discloses a nature-powered graph learning framework dubbed DS-GL. Rooted in a CMOS-compatible Ising machine, DS-GL inherits the extraordinary computational efficiency of the Ising machine and extends its potential to real-valued and larger-scale GL problems. Evaluations with four diverse GL applications across seven datasets show that DSGL can deliver speedups ranging from 10³× to 10⁵× over Graph Neural Networks on GPUs while operating at a power 2 orders of magnitude lower than GPUs, with 5%-30% accuracy enhancement.

### REFERENCES

I. Ahmed, P.-W. Chiu, and C. H. Kim, “A probabilistic self-annealing compute fabric based on 560 hexagonally coupled ring oscillators for solving combinatorial optimization problems,” in 2020 IEEE Symposium on VLSI Circuits, 2020, pp. 1-2.
“The D-Wave 2000Q quantum computer.” [Online]. Available: dwavesys.com/sites/default/files/D-Wave % 202000Q % 20Tech % 20Collateral 0117F.pdf
Andrew D King, Sei Suzuki, Jack Raymond, Alex Zucca, Trevor Lanting, Fabio Altomare, Andrew J Berkley, Sara Ejtemaee, Emile Hoskinson, Shuiyuan Huang, et al. Coherent quantum annealing in a programmable 2,000 qubit ising chain. Nature Physics, 18(11): 1324-1328, 2022.
Anshujit Sharma, Richard Afoakwa, Zeljko Ignjatovic, and Michael Huang. Increasing ising machine capacity with multi-chip architectures. In Proceedings of the 49th Annual International Symposium on Computer Architecture, pp. 508-521, 2022.
B. Zhang, H. Zeng, and V. K. Prasanna, “GraphAGILE: An fpga-based overlay accelerator for low-latency GNN inference,” IEEE Transactions on Parallel and Distributed Systems, vol. 34, no. 9, pp. 2580-2597, 2023.
Barry A Cipra. An introduction to the ising model. The American Mathematical Monthly, 94(10): 937-959, 1987.
Bikas K Chakrabarti, Amit Dutta, and Parongama Sen. Quantum Ising phases and transitions in transverse Ising models, volume 41. Springer Science & Business Media, 2008.
C Wu, T Geng, A Guo, S Bandara, P Haghi, C Liu, A Li, and M Herbordt. Fasda: An fpgaaided, scalable and distributed accelerator for range-limited molecular dynamics. In International Conference for High Performance Computing, Networking, Storage and Analysis, 2023.
Centers for Disease Control and Prevention, “COVID data tracker,” Atlanta, GA: U.S. Department of Health and Human Services, CDC, Nov. 22 2023, covid.cdc.gov/covid-data-tracker.
D Bitko, TF Rosenbaum, and G Aeppli. Quantum critical behavior for a model magnet. Physical review letters, 77(5): 940, 1996.
F. Frasca, B. Bevilacqua, M. Bronstein, and H. Maron, “Understanding and extending subgraph GNNs by rethinking their symmetries,” Advances in Neural Information Processing Systems, vol. 35, pp. 31 376-31 390, 2022.
Feng-Feng Song and Guang-Ming Zhang. Hybrid berezinskii-kosterlitz-thouless and ising topological phase transition in the generalized two-dimensional xy model using tensor networks. Physical Review B, 103(2): 024518, 2021.
G. E. Hinton, “A practical guide to training restricted Boltzmann machines,” in Neural Networks: Tricks of the Trade: Second Edition. Springer, 2012, pp. 599-619.
Gon: End-to-end optimization framework for constraint graph optimization problems. Knowledge-Based Systems, 254:109697, 2022.
H. Lo, W. Moy, H. Yu, S. Sapatnekar, and C. H. Kim, “An Ising solver chip based on coupled ring oscillators with a 48-node all-to-all connected array architecture,” Nature Electronics, vol. 6, no. 10, pp. 771-778, 2023.
H. Yu, Y. Zhang, J. Zhao, Y. Liao, Z. Huang, D. He, L. Gu, H. Jin, X. Liao, H. Liu, B. He, and J. Yue, “RACE: An efficient redundancyaware accelerator for dynamic graph neural network,” ACM Trans. Archit. Code Optim., August 2023, just Accepted.
Hai-Cheng Yi, Zhu-Hong You, De-Shuang Huang, and Chee Keong Kwoh. Graph representation learning in bioinformatics: trends, methods and applications. Briefings in Bioinformatics, 23(1): bbab340, 2021.
Henning Labuhn, Daniel Barredo, Sylvain Ravets, Sylvain De L'es'eleuc, Tommaso Macr'ι, Thierry Lahaye, and Antoine Browaeys. Tunable two-dimensional arrays of single rydberg atoms for realizing quantum ising models. Nature, 534(7609): 667-670, 2016.
J. Baek, M. Kang, and S. J. Hwang, “Accurate learning of graph representations with graph multiset pooling,” in International Conference on Learning Representations, 2020.
J. Chou, S. Bramhavar, S. Ghosh, and W. Herzog, “Analog coupled oscillator based weighted Ising machine,” Scientific Reports, vol. 9, no. 1, p. 14786, 2019. [Online]. Available: doi.org/10.1038/s41598-019-49699-5
J. Karras, A. Holynski, T.-C. Wang, and I. Kemelmacher-Shlizerman, “DreamPose: Fashion video synthesis with stable diffusion,” in Proceedings of the IEEE/CVF International Conference on Computer Vision, 2023, pp. 22 680-22 690.
Jacek Dziarmaga. Dynamics of a quantum phase transition: Exact solution of the quantum ising model. Physical review letters, 95(24): 245701, 2005.
Jie Zhou, Ganqu Cui, Shengding Hu, Zhengyan Zhang, Cheng Yang, Zhiyuan Liu, Lifeng Wang, Changcheng Li, and Maosong Sun. Graph neural networks: A review of methods and applications. AI open, 1:57-81, 2020.
Jinyin Chen, Xueke Wang, and Xuanheng Xu. Gc-Istm: Graph convolution embedded Istm for dynamic network link prediction. Applied Intelligence, pp. 1-16, 2022.
Jonathan Shlomi, Peter Battaglia, and Jean-Roch Vlimant. Graph neural networks in particle physics. Machine Learning: Science and Technology, 2(2): 021001, 2020. Jun Wu, Jingrui He, and Jiejun Xu. Net: Degree-specific graph neural networks for node and graph classification. In Proceedings of the 25th ACM SIGKDD International Conference on Knowledge Discovery & Data Mining, pp. 406-415, 2019a.
Keyulu Xu, Weihua Hu, Jure Leskovec, and Stefanie Jegelka. How powerful are graph neural networks? arXiv preprint arXiv: 1810.00826, 2018.
L. Kong, X. Tang, J. Zhu, Z. Wang, J. Li, H. Wu, Q. Wu, H. Chen, L. Zhu, W. Wang, B. Liu, Q. Wang, D. Chen, Y. Pan, T. Song, F. Li, H. Zheng, G. Jia, M. Lu, L. Wu, and G. R. Carmichael, “A 6-yearlong (2013-2018) high-resolution air quality reanalysis dataset in China based on the assimilation of surface observations from CNEMC,” Earth System Science Data, vol. 13, no. 2, pp. 529-570, 2021.
Liangwei Yang, Zhiwei Liu, Yingtong Dou, Jing Ma, and Philip S. Yu. Consisrec: Enhancing gnn for social recommendation via consistent neighbor aggregation. In Proceedings of the 44th International ACM SIGIR Conference on Research and Development in Information Retrieval, pp. 2141-2145, 2021.
M Yamaoka et al., “24.3 20k-spin Ising chip for combinational optimization problem with CMOS annealing,” in 2015 IEEE International Solid-State Circuits Conference-(ISSCC) Digest of Technical Papers. IEEE, 2015, pp. 1-3.
M. Yamaoka, C. Yoshimura, M. Hayashi, T. Okuyama, H. Aoki, and H. Mizuno, “A 20k-spin Ising chip to solve combinatorial optimization problems with CMOS annealing,” IEEE Journal of Solid-State Circuits, vol. 51, no. 1, pp. 303-309, 2015.
MC Arnesen, S Bose, and V Vedral. Natural thermal and magnetic entanglement in the 1d heisenberg model. Physical Review Letters, 87(1): 017901, 2001.
Michael E Fisher. Magnetism in one-dimensional systems—the heisenberg model for infinite spin. American Journal of Physics, 32(5): 343-346, 1964.
Muhan Zhang and Yixin Chen. Link prediction based on graph neural networks. Advances in neural information processing systems, 31, 2018.
N. Elgiriyewithana, “World weather repository (daily updating) [dataset].kaggle.com,” 2023.
O. Onyshchak, “Stock market dataset,” 2020. [Online]. Available: kaggle.com/dsv/1054465
P. L. McMahon, A. Marandi, Y. Haribara, R. Hamerly, C. Langrock, S. Tamate, T. Inagaki, H. Takesue, S. Utsunomiya, K. Aihara, R. L. Byer, M. M. Fejer, H. Mabuchi, and Y. Yamamoto, “A fully programmable 100-spin coherent Ising machine with all-to-all connections,” Science, vol. 354, no. 6312, pp. 614-617, 2016.
P. Mooney, “Zillow house price data [dataset].kaggle.com,” 2021.
Peter Schauß, Johannes Zeiher, Takeshi Fukuhara, Sebastian Hild, Marc Cheneau, Tommaso Macr'ι, Thomas Pohl, Immanuel Bloch, and Christian Groß. Crystallization in ising quantum magnets. Science, 347(6229): 1455-1458, 2015.
R. Afoakwa, Y. Zhang, U. K. R. Vengalam, Z. Ignjatovic, and M. Huang, “BRIM: Bistable resistively-coupled Ising machine,” in 2021 IEEE International Symposium on High-Performance Computer Architecture (HPCA), 2021, pp. 749-760.
R. Harris, M. W. Johnson, T. Lanting, A. J. Berkley, J. Johansson, P. Bunyk, E. Tolkacheva, E. Ladizinsky, N. Ladizinsky, T. Oh, F. Cioata, I. Perminov, P. Spear, C. Enderud, C. Rich, S. Uchaikin, M. C. Thom, E. M. Chapple, J. Wang, B. Wilson, M. H. S. Amin, N. Dickson, K. Karimi, B. Macready, C. J. S. Truncik, and G. Rose. Experimental investigation of an eight-qubit unit cell in a superconducting optimization processor. Phys. Rev. B, 82:024511, July 2010. doi: 10.1103/PhysRevB.82.024511. URL link.aps.org/doi/10. 1103/PhysRevB.82.024511.
R. Jiang, Z. Wang, J. Yong, P. Jeph, Q. Chen, Y. Kobayashi, X. Song, S. Fukushima, and T. Suzumura, “Spatio-temporal meta-graph learning for traffic forecasting,” in Proceedings of the AAAI Conference on Artificial Intelligence, vol. 37, no. 7, 2023, pp. 8078-8086.
R. Sarkar, S. Abi-Karam, Y. He, L. Sathidevi, and C. Hao, “FlowGNN: A dataflow architecture for real-time workload-agnostic graph neural network inference,” in 2023 IEEE International Symposium on High-Performance Computer Architecture (HPCA), March 2023, pp. 1099-1112.
Renhe Jiang, ZhaonanWang, Jiawei Yong, Puneet Jeph, Quanjun Chen, Yasumasa Kobayashi, Xuan Song, Shintaro Fukushima, and Toyotaro Suzumura. Spatio-temporal meta-graph learning for traffic forecasting. In Proceedings of the AAAI Conference on Artificial Intelligence, volume 37, pp. 8078-8086, 2023.
Richard Afoakwa, Yiqiao Zhang, Uday Kumar Reddy Vengalam, Zeljko Ignjatovic, and Michael Huang. Brim: Bistable resistively-coupled ising machine. In 2021 IEEE International Symposium on High-Performance Computer Architecture (HPCA), pp. 749-760. IEEE, 2021.
S. G. Brush, “History of the Lenz-Ising model,” Reviews of modern physics, vol. 39, no. 4, p. 883, 1967.
S. Xie, S. R. S. Raman, C. Nᵢ, M. Wang, M. Yang, and J. P. Kulkarni, “Ising-CIM: A reconfigurable and scalable compute within memory analog Ising accelerator for solving combinatorial optimization problems,” IEEE Journal of Solid-State Circuits, vol. 57, no. 11, pp. 3453-3465, 2022.
Shengnan Guo, Youfang Lin, Ning Feng, Chao Song, and Huaiyu Wan. Attention based spatialtemporal graph convolutional networks for traffic flow forecasting. In Proceedings of the Thirty-Third AAAI Conference on Artificial Intelligence and Thirty-First Innovative Applications of Artificial Intelligence Conference and Ninth AAAI Symposium on Educational Advances in Artificial Intelligence, AAAI'19/IAAI'19/EAAI'19. AAAI Press, 2019. ISBN 978-1-57735-809-1. doi: 10.1609/aaai.v33101.3301922. URL doi.org/10.1609/aaai.v33101.3301922.
T. Geng, A. Li, R. Shi, C. Wu, T. Wang, Y. Li, P. Haghi, A. Tumeo, S. Che, S. Reinhardt, and M. C. Herbordt, “AWB-GCN: A graph convolutional network accelerator with runtime workload rebalancing,” in 2020 53rd Annual IEEE/ACM International Symposium on Microarchitecture (MICRO), 2020, pp. 922-936.
T. Geng, C. Wu, Y. Zhang, C. Tan, C. Xie, H. You, M. Herbordt, Y. Lin, and A. Li, “I-GCN: A graph convolutional network accelerator with runtime locality enhancement through islandization,” in MICRO-54: 54th Annual IEEE/ACM International Symposium on Microarchitecture, ser. MICRO '21. New York, NY, USA: Association for Computing Machinery, 2021, p. 1051-1063.
T. Honjo, T. Sonobe, K. Inaba, T. Inagaki, T. Ikuta, Y. Yamada, T. Kazama, K. Enbutsu, T. Umeki, R. Kasahara, K. ichi Kawarabayashi, and H. Takesue, “100,000-spin coherent Ising machine,” Science Advances, vol. 7, no. 40, p. eabh0952, 2021. [Online]. Available: science.org/doi/abs/10.1126/sciadv.abh0952
T. Inagaki, Y. Haribara, K. Igarashi, T. Sonobe, S. Tamate, T. Honjo, A. Marandi, P. L. McMahon, T. Umeki, K. Enbutsu, O. Tadanaga, H. Takenouchi, K. Aihara, K.-i. Kawarabayashi, K. Inoue, S. Utsunomiya, and H. Takesue, “A coherent Ising machine for 2000-node optimization problems,” Science, vol. 354, no. 6312, pp. 603-606, 2016.
T. Takemoto, M. Hayashi, C. Yoshimura, and M. Yamaoka, “2.6 a 2× 30k-spin multichip scalable annealing processor based on a processing in-memory approach for solving large-scale combinatorial optimization problems,” in 2019 IEEE International Solid-State Circuits Conference-(ISSCC). IEEE, 2019, pp. 52-54.
T. Wang and J. Roychowdhury, “OIM: Oscillator-based Ising machines for solving combinatorial optimisation problems,” in Unconventional Computation and Natural Computation, I. McQuillan and S. Seki, Eds. Cham: Springer International Publishing, 2019, pp. 232-256.
Tadashi Kadowaki and Hidetoshi Nishimori. Quantum annealing in the transverse ising model. Physical Review E, 58(5): 5355, 1998.
Takahiro Inagaki, Yoshitaka Haribara, Koji Igarashi, Tomohiro Sonobe, Shuhei Tamate, Toshimori Honjo, Alireza Marandi, Peter L. McMahon, Takeshi Umeki, Koji Enbutsu, Osamu Tadanaga, Hirokazu Takenouchi, Kazuyuki Aihara, Ken ichi Kawarabayashi, Kyo Inoue, Shoko Utsunomiya, and Hiroki Takesue. A coherent ising machine for 2000-node optimization problems. Science, 354(6312): 603-606, 2016a. doi: 10.1126/science.aah4243. URL science. org/doi/abs/10.1126/science.aah4243.
Thomas N Kipf and Max Welling. Semi-supervised classification with graph convolutional networks. In International Conference on Learning Representations, 2016.
Tianshi Wang and Jaijeet Roychowdhury. Oim: Oscillator-based ising machines for solving combinatorial optimisation problems. In Ian McQuillan and Shinnosuke Seki (eds.), Unconventional Computation and Natural Computation, pp. 232-256, Cham, 2019. Springer International Publishing. ISBN 978-3-030-19311-9.
U. Vengalam, Y. Liu, T. Geng, H. Wu, and M. Huang, “Supporting energy-based learning with an Ising machine substrate: A case study on RBM,” in Proceedings of the International Symposium on Microarchitecture, 2023.
V. D. Blondel, J.-L. Guillaume, Rs. Lambiotte, and E. Lefebvre, “Fast unfolding of communities in large networks,” Journal of Statistical Mechanics: Theory and Experiment, vol. 2008, no. 10, p. P10008, October 2008.
W. Hou, K. Zhong, S. Zeng, G. Dai, H. Yang, and Y. Wang, “NTGAT: A graph attention network accelerator with runtime node tailoring,” in Proceedings of the 28th Asia and South Pacific Design Automation Conference, ser. ASPDAC '23. New York, NY, USA: Association for Computing Machinery, 2023, p. 645-650.
W. Moy, I. Elshazly, P.-w. Chiu, J. Moy, S. Sapatnekar, and C. Kim, “A 1,968-node coupled ring oscillator circuit for combinatorial optimization problem solving,” Nature Electronics, vol. 5, 05 2022.
W. Weng, J. Fan, H. Wu, Y. Hu, H. Tian, F. Zhu, and J. Wu, “A decomposition dynamic graph convolutional recurrent network for traffic forecasting,” Pattern Recognition, vol. 142, p. 109670, 2023.
W.-H. Hu, S. E. Lee, and N. Bagherzadeh, “DMesh: a diagonally-linked mesh network-on-chip architecture,” Network on Chip Architectures, vol. 14, 2008.
W.-L. Chiang, X. Liu, S. Si, Y. Li, S. Bengio, and C.-J. Hsieh, “Cluster-gcn: An efficient algorithm for training deep and large graph convolutional networks,” in Proceedings of the 25th ACM SIGKDD international conference on knowledge discovery & data mining, 2019, pp. 257-266.
Weiwei Jiang and Jiayun Luo. Graph neural network for traffic forecasting: A survey. Expert Systems with Applications, 207:117921, 2022.
Wenchao Weng, Jin Fan, Huifeng Wu, Yujie Hu, Hao Tian, Fu Zhu, and Jia Wu. A decomposition dynamic graph convolutional recurrent network for traffic forecasting. Pattern Recognition, 142:109670, 2023. ISSN 0031-3203. doi: doi.org/10.1016/j.patcog. 2023.109670. URL sciencedirect.com/science/article/pii/S0031320323003710.
Xavier Leoncini, Alberto D Verga, and Stefano Ruffo. Hamiltonian dynamics and the phase transition of the xy model. Physical Review E, 57(6): 6377, 1998.
Xing Lin, Yair Rivenson, Nezih T. Yardimci, Muhammed Veli, Yi Luo, Mona Jarrahi, and Aydogan Ozcan. All-optical machine learning using diffractive deep neural networks. Science, 361(6406): 1004-1008, 2018. doi: 10.1126/science.aat8084. URL science.org/doi/abs/10.1126/science.aat8084.
Y. Yamamoto, K. Aihara, T. Leleu, K.-i. Kawarabayashi, S. Kako, M. Fejer, K. Inoue, and H. Takesue, “Coherent Ising machines-optical neural networks operating at the quantum limit,” npj Quantum Information, vol. 3, no. 1, p. 49, 2017.
Y. Zhang, H. You, Y. Fu, T. Geng, A. Li, and Y. Lin, “G-CoS: Gnn-accelerator co-search towards both better accuracy and efficiency,” 2021 IEEE/ACM International Conference On Computer Aided Design (ICCAD), pp. 1-9, 2021.
Z. Liu, Y. Yang, Z. Pan, A. Sharma, A. Hasan, C. Ding, A. Li, M. Huang, and T. Geng, “Ising-CF: A pathbreaking collaborative filtering method through efficient Ising machine learning,” in Proceedings of the 60th ACM/IEEE Design Automation Conference. of DAC, 2023.
Z. Pan, A. Sharma, J. Y.-C. Hu, Z. Liu, A. Li, H. Liu, M. Huang, and T. Geng, “Ising-Traffic: Using Ising machine learning to predict traffic congestion under uncertainty,” Proceedings of the AAAI Conference on Artificial Intelligence, vol. 37, no. 8, pp. 9354-9363 June 2023. [Online]. Available: ojs.aaai.org/index.php/AAAI/article/view/26121
Z. Wu, S. Pan, G. Long, J. Jiang, and C. Zhang, “Graph WaveNet for deep spatial-temporal graph modeling,” 2019.
Z. Wu, S. Pan, G. Long, J. Jiang, X. Chang, and C. Zhang, “Connecting the dots: Multivariate time series forecasting with graph neural networks,” in Proceedings of the 26th ACM SIGKDD international conference on knowledge discovery & data mining, 2020, pp. 753-763.
Zhenyu Pan, Anshujit Sharma, Jerry Yao-Chieh Hu, Zhuo Liu, Ang Li, Han Liu, Michael Huang, and Tony Geng. Ising-traffic: Using ising machine learning to predict traffic congestion under uncertainty. Proceedings of the AAAI Conference on Artificial Intelligence, 37(8): 9354-9363 June 2023. doi: 10.1609/aaai.v37i8.26121. URL ojs.aaai.org/index.php/AAAI/article/view/26121.
Zhuo Liu, Yunan Yang, Zhenyu Pan, Anshujit Sharma, Amit Hasan, Caiwen Ding, Ang Li, Michael Huang, and Tong Geng. Ising-cf: A pathbreaking collaborative filtering method through efficient ising machine learning. In Proceedings of the 60th ACM/IEEE Design Automation Conference. of DAC, 2023.
Zonghan Wu, Shirui Pan, Guodong Long, Jing Jiang, and Chengqi Zhang. Graph wavenet for deep spatial-temporal graph modeling, 2019b.
Zonghan Wu, Shirui Pan, Guodong Long, Jing Jiang, Xiaojun Chang, and Chengqi Zhang. Connecting the dots: Multivariate time series forecasting with graph neural networks, 2020.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A system for data analysis and prediction, comprising:
at least one processing unit configured to divide input data into multiple partitions, wherein each partition comprises nodes corresponding to previous, current, and future time states represented as spins, and wherein the processing unit is configured to fix the spins of the nodes of the previous and current time steps to historical data; and
one or more Ising machines coupled to the at least one processing unit configured to predict spins of nodes for future time states by evolving the system toward a spin configuration with the lowest energy state.

2. The system of claim 1, wherein the one or more Ising machines implement a Hamiltonian function modified to support any of real-valued state data, dynamical machines, machine learning (ML), graph learning, and any combinations thereof.

3. The system of claim 1, wherein the at least one processing unit comprises a mesh-based network of a plurality of processing elements (PEs) connected to a plurality of coupling units (CUs).

4. The system of claim 3, wherein each PE comprises at least one of one or more buffers, routers, and digital controllers for support of co-annealing in the processing unit.

5. The system of claim 4, wherein each CU comprises a mini coupling crossbar configurable for one or more types of connections to bridge neighboring PEs.

6. The system of claim 3, wherein the mesh-based network comprises direct interconnections between non-neighboring PEs to reduce communication latency.

7. The system of claim 1, wherein the evolution toward the spin configuration with the lowest energy state is achieved using a co-annealing process that integrates spatial and temporal relationships.

8. The system of claim 1, wherein the one or more Ising machine are configured for electron-speed annealing with asynchronous spin flipping.

9. The system of claim 1, wherein one or more of the spins are allowed to stabilize at intermediate states.

10. The system of claim 1, wherein coupling strengths between spins are learned during a training phase such that historical data corresponds to a lower-energy configuration than alternative configurations.

11. The system of claim 1, wherein the processing unit and one or more Ising machines are coupled using a mesh-based architecture with a plurality of interconnected processing elements.

12. The system of claim 1, wherein the processing unit is configured to selectively establish direct coupling paths between non-adjacent processing elements of the processing unit to exchange spin information.

13. The system of claim 1, wherein each node comprises a resistive feedback loop configured to regulate current flow and stabilize a node state at a non-binary value.

14. The system of claim 1, wherein the predictions for future nodes are used in real-time applications, including live data, graph data, live graph data, traffic forecasting, air quality monitoring, disease or pandemic progression modeling.

15. The system of claim 1, further comprising a visualization module to display predicted future data alongside historical data for analysis.

16. The system of claim 1, wherein the system is CMOS-based.

17. The system of claim 1, wherein the one or more Ising machines comprise modified Ising machines configured to represent or embody one or more dynamical systems.

18. A method for data analysis and prediction, comprising:
providing the system of claim 1;
dividing input data into multiple partitions, wherein each partition comprises nodes corresponding to previous, current, and future time states represented by spins;
fixing the spins of the nodes in the partitions corresponding to the previous and current time states based on historical data;
representing the data as an energy-based model with parameters that define relationships between nodes;
evolving the model toward a configuration with the lowest energy state using one or more Ising machines; and
predicting the spins of nodes in the partition corresponding to the future time states based on the evolved configuration, and inferring data based on the prediction.

19. The method of claim 18, wherein the data analysis and prediction is used for any of dynamical machines, graph-based predictions, traffic flow predictions, pandemic progression modelling, air quality monitoring, optimization problems, supply chain optimization, network optimization, machine learning, real-time dynamic systems, disaster response, molecular simulations, energy optimization, real-valued data prediction.

20. The method of claim 18, wherein the one or more Ising machines comprise modified Ising machines configured to represent or embody one or more dynamical systems.
